(19) United States
(12) Patent Application Publication
(10) Pub. No.: US 2015/0329785 A1
(43) Pub. Date: Nov. 19, 2015

(54) METHOD AND APPARATUS FOR GENERATING AND/OR HYDROTREATING HYDROCARBON FORMATION FLUIDS

(71) Applicants: Harold VINEGAR, Bellaire, TX (US); Scott NGUYEN, Austin, TX (US)

(72) Inventors: Harold VINEGAR, Bellaire, TX (US); Scott NGUYEN, Austin, TX (US)

(73) Assignee: GENIE IP B.V., Amsterdam (NL)

(21) Appl. No.: 14/412,698

(22) PCT Filed: Apr. 16, 2013
(86) PCT No.: PCT/IB2013/053027

§ 371 Date: Jan. 5, 2015

Related U.S. Application Data
(63) Continuation of application No. PCT/US13/36674, filed on Apr. 15, 2013.
(60) Provisional application No. 61/668,003, filed on Jul. 4, 2012.
(60) Provisional application No. 61/738,393, filed on Dec. 17, 2012.
(60) Provisional application No. 61/759,309, filed on Jan. 31, 2013.
(60) Provisional application No. 61/787,183, filed on Mar. 15, 2013.

(51) Int. Cl. C10G 1/02; E21B 43/24; C10G 45/04; C10L 1/04; C09K 8/58; C10G 1/00

(52) U.S. Cl. CPC C10G 1/02; C09K 8/58; C10G 1/002; C10G 45/04; C10L 1/04; E21B 43/24; C10L 2290/02

(57) ABSTRACT

Some embodiments relate to a method for producing, from sulfur-rich type IIs kerogen, a sweetened synthetic crude having a sulfur concentration of at most 1% wt/wt, a nitrogen concentration of at most 0.2% wt/wt and an API gravity of at least 30°. Hydrotreating is performed under only low-severity conditions of at most about 350 degrees Celsius and a maximum pressure of at most 120 atmospheres. In some embodiments, the feedstock to the hydrotreater comprises hydrocarbon pyrolysis liquids generated primarily by low temperature pyrolysis of the sulfur-rich type IIs kerogen. For example, the feedstock may be rich in easier-to-hydrotreat heterocyclic species. In some embodiments, it is possible to optimize the pyrolysis process by monitoring relative concentrations of the easier-to-hydrotreat heterocyclics and the harder-to-treat heterocyclics.

### FIELD OF THE INVENTION

Embodiments of the invention relate to techniques for pyrolyzing type IIs kerogen compositions derived therefrom, and to related methods of hydrotreating.

### BACKGROUND

The world's supply of conventional sweet, light crude oil is declining, and discoveries and access to new resources for this premium oil are becoming more challenging. To supplement this decline and to meet the rising global demand, oils of increasing sulfur content are being produced and brought to market. Sources of sulfur-rich oil may be found in Canada, Venezuela, the United States (California), Mexico and the Middle East.

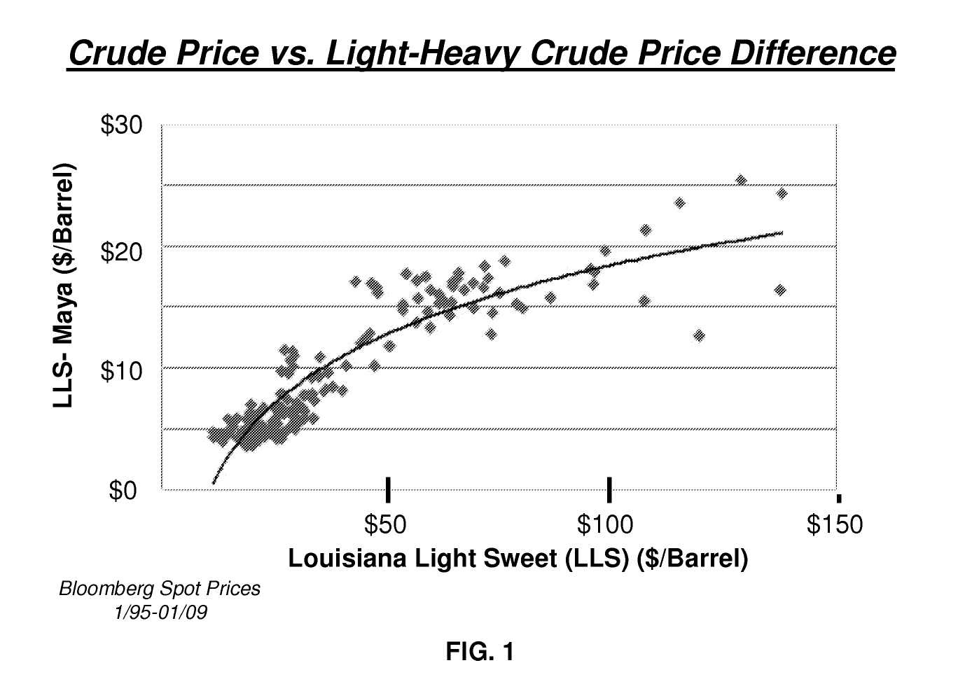

Although sulfur-rich oils, such as Maya crude, contribute significantly to the world's oil reserves, the economic and environmental costs of refining heavy oils can be significant. FIG. 1 illustrates the price differential between Louisiana Light Sweet (LLS) and Maya crude oils as a function of LLS ($/barrel) spot price. As illustrated in FIG. 1, at the price of $75 per barrel for the LLS crude oil, the price differential for the Maya crude oil is about $15 per barrel more.

Many sulfur-rich hydrocarbons are sourced from a subset of Type II kerogen known to be sulfur-rich, called Type II-s or IIs. A schematic representation of one type of organic matter in Type IIs kerogen is illustrated below:

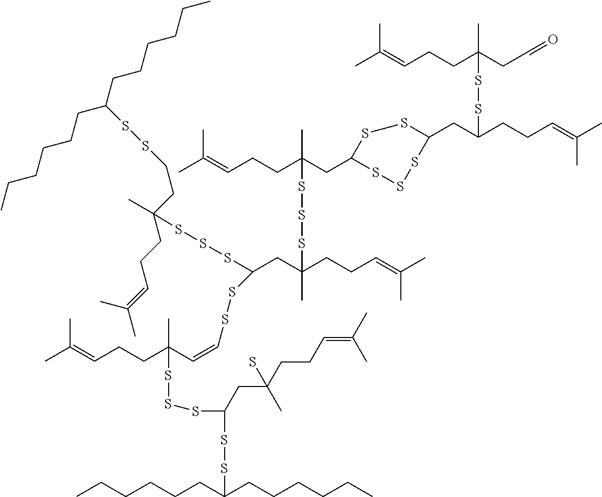 [SMILES: CCCCCCC(CCCCCC)SSCCC(C)(CCC=C(C)C)SSSC(CC(C)(CCC=C(C)C)SSSC(C)(CCC=C(C)C)CC1SSSC(CC(CCC=C(C)C)SSC(C)(CC=O)CCC=C(C)C)SS1)SS/C=C\C(C)(CCC=C(C)C)SSSC(CC(C)(S)CCC=C(C)C)SSC(CCCCCC)CCCCCC]

Originating from a marine-depositional environment, Type II-s kerogen is rich in sulfur-bearing organic compounds, and during thermal maturation produces oil and bitumen with high sulfur content. For example, the oil produced in some Iraqi oil fields have sulfur content of ˜4%.

Sulfur-rich oils include both conventional oils as well as unconventional oils. As conventional oil becomes less available (e.g. due to the increased cost of producing conventional oil from remote locations) and/or unable to meet world demand, it can be replaced with production of unconventional oils. Unconventional oils may be derived from a number of sources, including but not limited to oil sands, oil shale, coal, biomass, and bitumen deposits.

Presently, however, sulfur-rich oils are expensive to develop and bring to market for a variety of reasons. Sulfur rich oils must be treated with costly hydrogen gas during the refining process to lower the sulfur content of the oil, a process called hydrodesulfurization. Hydrotreating includes the effort to hydrodesulfurize and hydrodenitrify. Furthermore, sulfur rich oils are typically hydrotreated in sturdy but costly vessels due to the high pressures and temperatures required. When the sulfur-rich oils include significant quantities of metals, their presence of them may poison the catalysts, thereby requiring larger quantities of expensive catalyst.

Embodiments of the present invention relate to apparatus, methods and compositions associated with oil production from sulfur-rich Type IIs kerogen. One example of a Type IIs kerogen is kerogen of the Ghareb formation of Jordan.

### SUMMARY OF THE INVENTION

Embodiments of the present invention relate to a novel technique for pyrolyzing sulfur-rich type IIs kerogen, a novel oil derived therefrom, and novel techniques for hydrotreating the same at only low-severity conditions.

By slowly pyrolyzing sulfur-rich Type IIs kerogen at relatively low temperatures, it is possible to obtain an oil which is surprisingly easy to hydrotreat, despite its relatively high sulfur content. In some embodiments, this ease of hydrotreating relates to one or more of the following properties: (i) a relatively high concentration of alkylthiophene relative to multi-ring sulfur heterocycles such as benzothiophenes or dibenzothiophenes and/or (ii) a relatively high concentration of low molecular weight alkylthiophene (i.e. C1-C3 alkylthiophenes) relative to higher molecular weight alkylthiophenes.

Speciation experiments conducted on a blend of hydrocarbon pyrolysis liquids derived from Ghareb formation oil shale indicates that an abundance of C3 thiophenes and a substantial lack or complete absence of C4+ thiophenes. Furthermore, analysis of these pyrolysis liquids shows that they are both alkylthiophene rich and surprisingly easy to hydrotreat.

Analogously, it is believed that oils derived by low-temperature pyrolysis of type IIs kerogen are (i) relatively rich in alkylpyridines compared to a concentration of multi-ring nitrogen basic heterocycles (i.e. alkylquinolines, alkylisoquinolines and alkylacridines); and (ii) relatively rich in alkylpyrroles compared to a concentration of multi-ring nitrogen neutral heterocycles (i.e. *alkylindoles and alkylcarbazoles).

Analogously, it is believed that low-temperature pyrolysis of type IIs kerogen tends to favor formation of lower molecular-weight pyridine and pyrrole species, with little or no formation of higher molecular-weight pyridine and pyrrole species.

Advantageously, these lower molecular-weight single-ring heterocyclic compounds are significantly easier to hydrotreat than their multi-ring and/or higher-molecular weight counterparts. As noted below, it is possible to regulate the pyrolysis process so as to favor formation of heterocyclic species which are easier to subsequently hydrotreat.

Furthermore, experiments conducted on the aforementioned oil blend of hydrocarbon pyrolysis liquids derived from Ghareb formation oil shale indicates that this oil is surprisingly easy to hydrotreat. In particular, experiments indicate that it is possible to produce, from sulfur-rich type IIs kerogen, a light, sweet synthetic crude oil having a sulfur content of at most 1% wt/wt and a nitrogen content of at most 0.2% wt/wt without relying on external sources of hydrogen gas (e.g. using only hydrogen gas formed by pyrolysis of the kerogen) and/or whereby hydrocarbon liquids are subjected to at most low-severity hydrotreatment.

In some embodiments, it is possible to optimize the ease of hydrotreating by maximizing the amount of pyrolysis that occurs at very low temperatures—e.g. between 270 and 290 degrees Celsius. Kinetics experiments for the pyrolysis of kerogen of oil shale from the Ghareb formations indicates that a rate of pyrolysis is surprisingly high at these low temperatures. Thus, it is possible to arrange heater well spacing and/or regulate power of subsurface heaters in order to maximize the amount of low-temperature pyrolysis.

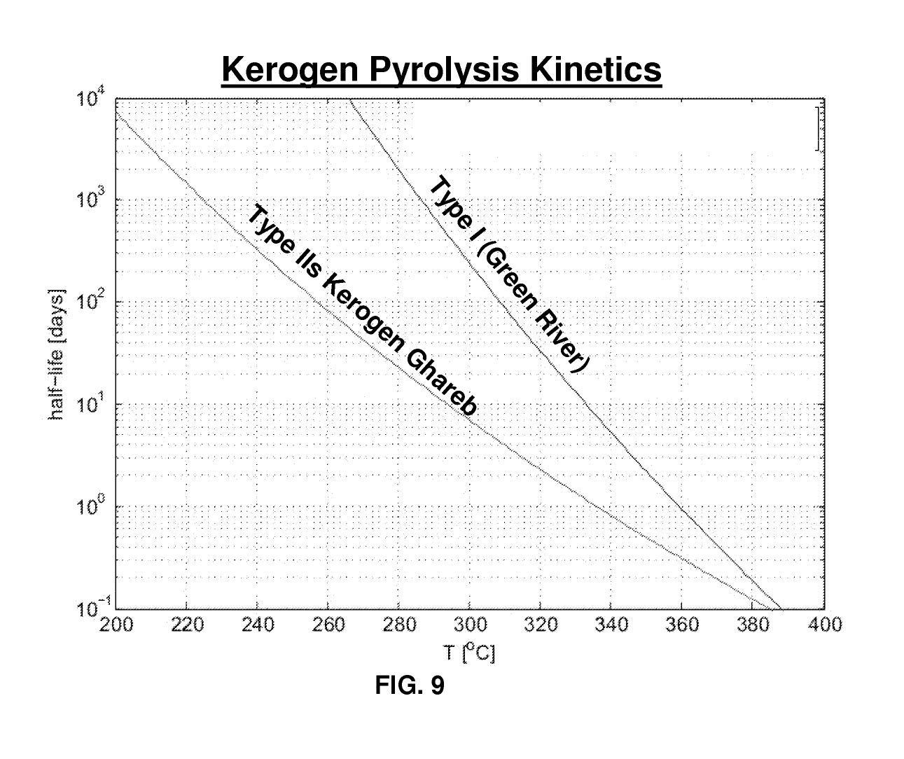

As discussed below with reference to FIG. 9, it is believed that lower temperature pyrolysis below 300 degrees Celsius, tends to favor formation of species that are easier to hydrotreat such as thiophenes. This situation is in contrast to conventional pyrolysis temperatures where smaller quantities of thiophenes are formed, and which favor formation of harder to hydrotreat dibenzothiophenes.

Thus, in some embodiments, a majority or a substantial majority of kerogen of a portion (for example, a target portion having length, width and height of at least 20 meters, or at least 50 meters, or at least 100 meters, or at least 150 meters) of a formation is pyrolyzed in a temperature range between 270 and 290 degrees Celsius.

Alternatively or additionally, in embodiments related to in situ pyrolysis, it is possible to regulate a power level of subsurface heaters so as to maximize, within the hydrocarbon pyrolysis formation liquids, at least one of: (i) a fraction of sulfur heterocycles that are alkylthiophenes; (ii) a fraction of basic nitrogen heterocycles that are alkylpyridines; (iii) a fraction of neutral nitrogen heterocycles that are alkylpyrroles. For example, it may be possible to monitor any of the aforementioned fractions, and in response to a monitored value or a change therein, increase or decrease a power level of one or more of the subsurface heaters.

Alternatively or additionally, in embodiments related to in situ pyrolysis, it is possible to regulate a power level of subsurface heaters so as to maximize, within the hydrocarbon pyrolysis formation liquids, at least one of: (i) a ratio between a concentration of alkylthiophenes and a concentration of alkylbenzothiophenes; (ii) a ratio between a concentration of alkylthiophenes and a concentration of alkyldibenzothiophenes; (ii) a ratio between a concentration of alkylpyridines and a sum of concentrations of alkylquinolines and alkylisoquinolines; (iii) a ratio between a concentration of alkylpyridines and a concentration of alkylacridines; (iv) a ratio between a concentration of alkylpyrroles and a concentration of alkylindoles; (v) a ratio between a concentration of alkylpyrroles and a concentration of alyklcarbazoles. For example, it may be possible to monitor any of the aforementioned ratios, and in response to a monitored value or a change therein, increase or decrease a power level of one or more of the subsurface heaters.

As noted above, one advantage of the presently disclosed hydrocarbon pyrolysis liquids derived from relatively low temperature and/or slow pyrolysis of type IIs kerogen is the predominance of easier-to-hydrotreat alkylthiophenes relative to harder-to-hydrotreat alkylbenzothiophenes and alkyldibenzothiophenes. Furthermore, speciation experiments performed on the aforementioned oil blend of hydrocarbon pyrolysis liquids derived from Ghareb formation oil shale indicate that the relative concentration of the different species of alkylthiophenes follow a definitive pattern. In particular, speciation data indicates that substantially all thiophenes are C2-C3 thiophenes, with low concentration of C1 thiophenes and even lower concentrations of both thiophene C₄H₄S as well as C4+ thiophenes.

Although C2-C3 thiophenes are slightly or somewhat harder to hydrotreat than C1 thiophene or thiophene C₄H₄S, they are significantly easier to hydrotreat than the multi-ring heterocyclics, or than the heavier C4+ or C5+ or C6+ or C7+ alyklthiophenes. The surprising predominance of C2-C3 thiophenes is advantageous because: (i) these species are ‘easy enough’ to hydrotreat and (ii) in contrast to hydrotreatment of thiophene C₄H₄S which produces less valuable and non-condensable butane, hydrotreating of C2-C3 thiophenes produces more valuable hexane and heptane.

Towards this end, in some embodiments related to in situ pyrolysis, it is possible to regulate a power level of subsurface heaters so as to maximize, within the hydrocarbon pyrolysis formation liquids, at least one of: (i) a ratio between concentrations of C3 alkylthiophenes and C4 alkylthiophenes; (ii) a ratio between concentrations of C3 alkylpyridines and C4 alkylpyridines; (iii) a ratio between concentrations of C2 alkylpyridines and C3 alkylpyridines; (iv) a ratio between concentrations of C3 alkylpyrroles and C4 alkylpyrroles; (v) a ratio between concentrations of C2 alkylpyrroles and C3 alkylpyrroles.

Furthermore, preliminary GC results for the aforementioned blend of hydrocarbon pyrolysis liquids indicate that at most small quantities of ethyl-thiophene are formed by low-temperature pyrolysis of type IIs kerogen. This indicates that a substantial majority, or substantially all C2 alkylthiophenes are di-methyl thiophenes rather than ethyl-thiophenes. The present inventors propose a pyrolysis mechanism related to slow pyrolysis of kerogen comprising sulfur cross-linked chlorophyll chains at low pyrolysis temperature (e.g. in the range between 270 and 290 degrees Celsius).

According to this proposed mechanism, at temperatures between 270 and 290 degrees Celsius, the weakest sulfur-sulfur bonds are the first to be broken. In a Type IIs kerogen, S—S bonds crosslink the chlorophyll chains comprising a backbone of about 20 carbon atoms. After the S—S bond is thermally cleaved, the backbone ‘folds around’ and forms an alkylated thiophene having one or more CN alkyl groups where N is a ‘large’ number (e.g. typically about 20 carbons in naturally-occurring high sulfur oils derived from Type IIs kerogen)). However, unlike the naturally-occurring oils, when the kerogen is maintained at the low pyrolysis temperatures between 270 and 290 degrees C. for a relatively ‘long’ period of time, the kinetics favor breaking the long carbon chains at their weakest point, leaving only relatively stable methyl groups attached to the thiophene ring. The low temperature long duration pyrolysis yields primarily methyl-thiophene or di-methyl-thiophene or tri-methyl-thiophene or tetra-methyl-thiophene.

Thus, when kerogen is exposed to these low-temperature pyrolysis temperatures for a relatively long period of time, significant quantities of alkylated thiophenes may be yielded, where the thiophene ring is alkylated only by one or more methyl group(s).

Not wishing to be bound by theory, it is believed that this is in contrast to conventional oil formed from Type IIs kerogen over millions of years at significantly lower temperatures, where not enough energy is provided to cleave the C—C bond at its first position to yield methylated thiophenes, and where most alklylated thiophenes are CN alkyl thiophenes where N is relatively ‘large,’ being equal to at least 5 or at least 10 or at least 20.

Not wishing to be bound by theory, it is believed that this is also in contrast to pyrolysis liquids generated from conventional high-temperature, ‘fast-heating’ surface retorts, which are known to generate mostly high-molecular weight species, including sulfur-bearing compounds. These higher molecular weight species comprise high concentrations of multi-ring aromatic compounds, including dibenzothiphenes and alkyl dibenzothiophenes, which are much more difficult to hydrotreat than the methylated thiophenes.

Embodiments of the present invention relate to techniques for producing, from sulfur-rich type IIs kerogen, a light, sweet synthetic crude oil having a sulfur content of at most 1% wt/wt and a nitrogen content of at most 0.2% wt/wt in a manner that is self-sufficient with respect to hydrogen gas and/or whereby hydrocarbon liquids are subjected to at most low-severity hydrotreatment.

By pyrolyzing the type IIs kerogen at relative low temperatures which are sustained for a relatively long period of time, it is possible to generate hydrocarbon pyrolysis formation fluids that are surprisingly easy to hydrotreat. Experimental data indicates that these formation fluids are rich in easier-to-hydrotreat heterocyclic species, in contrast to hydrocarbon formation fluids obtained from similar kerogen under higher temperature and/or ‘fast-heating’ conditions.

For the present disclosure, ‘low severity’ hydrotreating conditions are characterized by (i) a maximum temperature of at most 350 degrees Celsius or at most 340 degrees Celsius or at most 330 degrees Celsius; and (ii) a maximum pressure of at most 120 atmospheres (atm) or at most 110 atm or at most 100 atm or at most 90 atm or at most 80 atm or at most 70 atm.

For the present disclosure, the statement “hydrotreating is sustained only by the hydrogen gas component of the pyrolysis gases” includes only H₂ gas formed as a reaction product of the pyrolysis itself, and does not include hydrogen gas derived from steam methane reforming of the pyrolysis gases.

For the present disclosure, a process that is ‘self-sufficient with respect to hydrogen gas” consumes only the H2 gas formed as a reaction product of the pyrolysis itself, and does not include hydrogen gas derived from external hydrogen sources or steam methane reforming of the pyrolysis gases.

“Sulfur-rich” type IIs kerogen refers to type IIs kerogen having an average sulfur content of at least 8% wt/wt (in some embodiments, at least 10% wt/wt or at least 12% wt/wt) and an average nitrogen content of at least 1.5% wt/wt (in some embodiments, at least 1.75% wt/wt or at least 2% wt/wt).

Type IIs kerogen is pyrolyzed to form hydrocarbon pyrolysis fluids, which are hydrotreated only at low-severity conditions and/or without relying on external sources of hydrogen gas. In some examples, the pyrolysis is performed primarily at relatively low temperatures and/or in a manner that maximizes a ratio between respective concentrations of alkylthiophenes and alkyldibenzothiophenes within the resulting pyrolysis liquids. In some embodiments, the pyrolysis is performed in a manner that maximizes a fraction of alkylthiophenes that are either (i) unalkylated or (ii) alkylated only by one or more methyl groups. In some embodiments, the pyrolysis is performed in a manner that maximizes a fraction of alkylthiophenes that are (i) unalkylated or (ii) C1-C3 alkylthiophenes. In some embodiments, the pyrolysis is performed in a manner that maximizes a fraction of alkylthiophenes that are (i) unalkylated or (ii) C2-C3 alkylthiophenes.

It is believed that the pyrolysis primarily at low temperature is conducive for formation of relatively high concentrations lower-molecular-weight and single-ring heterocyclic species that are easier to hydrotreat than their multi-ring or higher-molecular-weight counterparts.

Although low-temperature pyrolysis may be significantly slower than pyrolysis at higher temperatures for well-studied kerogens such as Green River Type I kerogen, experiments commissioned by the present inventors indicate that type IIs kerogen, such as that in Ghareb formations, pyrolyzes at a surprisingly fast rate even at low temperatures of less than 290 degrees Celsius, where the pyrolysis liquids are relatively rich in easier-to-hydrotreat species.

In order to maintain the type IIs kerogen within a desired low-temperature pyrolysis range for sufficient time, it may be desirable to quickly ramp up to a desired low temperature pyrolysis temperature, and then to control heater power (e.g. reducing heater power) in a manner so as to prolong an amount of time the kerogen is maintained at ‘low’ range of pyrolysis temperatures below 290 degrees Celsius.

### DESCRIPTION OF EMBODIMENTS

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

If two numbers A and B are “on the same order of magnitude”, then ratio between (i) a larger of A and B and (ii) a smaller of A and B is at most 15 or at most 10 or at most 5.

Unless specified otherwise, a ‘substantial majority’ refers to at least 75%. Unless specified otherwise, ‘substantially all’ refers to at least 90%. In some embodiments ‘substantially all’ refers to at least 95% or at least 99%.

Embodiments of the present invention relate to compositions (e.g. oils) containing one or more types of heterocyclic compounds including (i) sulfur heterocyclic compounds such as the single-ring alkylthiophenes, or the multi-ringed alkylbenzothiophenes or alkyldibenzothiophenes and (ii) nitrogen heterocyclic compounds such as the single-ringed alkylpyridines or alkylpyrroles, or the multi-ringed alkylquinolines, alkylisoquinolines, alkylacridines, and alkylindoles, and alkylcarbazoles. The term ‘alkylthiophenes’ includes thiophene C₄H₄S as well as alkylated thiophenes. ‘Alkylated thiophenes’ are thiophenes where an alykl group is bonded to one or more locations on the thiophene ring. Thiophene C₄H₄S is an ‘alkylthiophene’ but is not an ‘alkylated thiophene.’ Examples of alkylated thiophenes include but are not limited to methyl thiophenes, di-methyl thiophenes, ethyl thiophenes, ethyl methyl-thiophenes, propyl thiophenes, etc. Analogous definitions (i.e. analogous to ‘alkylthiophenes’) apply to the multi-ring sulfur heterocyclic compounds (i.e. alkylbenzothiophenes and alkyldibenzothiophenes) to the single-ring nitrogen heterocyclic compounds (i.e. alkylpyridines and alkylpyrroles) and to the multi-ring nitrogen heterocyclic compounds (i.e. alkylquinolines, alkylisoquinolines alkylacridines, and alkylindoles and alkylcarbazoles).

By way of example, methyl thiophenes are a ‘C1 alkylthiophene’ because the total number of carbon atoms of alkyl groups bonded to a member of the thiophene ring is exactly 1. Both di-methyl thiophenes and ethyl thiophenes are ‘C2 alkylthiophenes’ because the total number of carbon atoms of bonded-alkyl group(s) bounded to a member of thiophene ring is exactly 2. C3 alkylthiophenes are molecules where the total number of carbon atoms of bonded-alkyl group(s) bounded to a member of thiophene ring is exactly 3—thus, C3 alkylthiophenes include tri-methyl thiophenes, methyl ethyl thiophenes and propyl thiophenes. Analogous definitions (i.e. analogous to ‘alkylthiophenes’) apply to the multi-ring sulfur heterocyclic compounds (i.e. alkylbenzothiophenes and alkyldibenzothiophenes) to the single-ring nitrogen heterocyclic compounds (i.e. alkylpyridines and alkylpyrroles) and to the multi-ring nitrogen heterocyclic compounds (i.e. alkylquinolines, alkylisoquinolines alkylacridines, and alkylindoles and alkylcarbazoles).

For a positive integer N, the terms ‘CN alkylthiophenes’ and ‘CN thiophenes’ are used synonymously and refer to alkylthiophenes (which also happen to be ‘alkylated thiophenes’) where the total number of carbon atoms of bonded-alkyl group(s) bounded to a member of thiophene ring is exactly N. Analogous definitions (i.e. analogous to ‘alkylthiophenes’) apply to the multi-ring sulfur heterocyclic compounds (i.e. alkylbenzothiophenes and alkyldibenzothiophenes) to the single-ring nitrogen heterocyclic compounds (i.e. alkylpyridines and alkylpyrroles) and to the multi-ring nitrogen heterocyclic compounds (i.e. alkylquinolines, alkylisoquinolines alkylacridines, and alkylindoles and alkylcarbazoles).

For a positive integer N, the terms ‘CN+ alkylthiophenes’ and ‘CN+ thiophenes’ are used synonymously and refer to alkylthiophenes (which also happen to be ‘alkylated thiophenes’) where the total number of carbon atoms of bonded-alkyl group(s) bounded to a member of thiophene ring is greater than or equal to N. Analogous definitions (i.e. analogous to ‘alkylthiophenes’) apply to the multi-ring sulfur heterocyclic compounds (i.e. alkylbenzothiophenes and alkyldibenzothiophenes) to the single-ring nitrogen heterocyclic compounds (i.e. alkylpyridines and alkylpyrroles) and to the multi-ring nitrogen heterocyclic compounds (i.e. alkylquinolines, alkylisoquinolines alkylacridines, and alkylindoles and alkylcarbazoles).

For positive integers N, M (M>N), the terms ‘CN-CM alkylthiophenes’ and ‘CN+ thiophenes’ are used synonymously and refer to alkylthiophenes (which also happen to be ‘alkylated thiophenes’) where the total number of carbon atoms of bonded-alkyl group(s) bounded to a member of thiophene ring is either (i) exactly N; or (ii) exactly M or (iii) greater than N and less than M. Analogous definitions (i.e. analogous to ‘alkylthiophenes’) apply to the multi-ring sulfur heterocyclic compounds (i.e. alkylbenzothiophenes and alkyldibenzothiophenes) to the single-ring nitrogen heterocyclic compounds (i.e. alkylpyridines and alkylpyrroles) and to the multi-ring nitrogen heterocyclic compounds (i.e. alkylquinolines, alkylisoquinolines, alkylacridines, and alkylindoles and alkylcarbazoles).

When determining concentration of alkylthiophenes (or, by analogy, alkylbenzothiophenes or alkyldibenzothiophenes or alkylpyridines and alkylpyrroles or alkylquinolines, or alkylisoquinolines or alkylacridines or alkylindoles or alkylcarbazoles), the location to which alkyl group(s) are attached is immaterial.

For the present invention, an ‘alkylthiophene-rich oil’ is an oil where a majority (or a substantial majority) of the sulfur compounds are alkylthiophenes and/or an oil that is at least 10% or at least 20% by volume alkylthiophene. For the present invention, an ‘alkylpyridine and/or alkylpyrrole rich oil’ is an oil where a majority (or a substantial majority) of the nitrogen compounds are alkylpyridines or alkylpyrroles and/or an oil that is at least 10% or at least by volume either alkylpyridines or alkylpyrroles.

For the present disclosure, a ‘sulfur-rich feedstock’ or a ‘sulfur-rich pyrolysis liquid’ is at least 3% wt/wt or at least 4% wt/wt sulfur.

For the present disclosure, sulfur-rich type IIs kerogen is at least 6% wt/wt or at least 7% wt/wt or at least 8% wt/wt sulfur.

For the present disclosure, ‘low temperature pyrolysis’ is pyrolysis that occurs at temperatures of at most 290 degrees Celsius over a period of at least 3 months or at least 6 months or at least 1 year. In some embodiments, ‘low temperature pyrolysis’ occurs between 270 degrees Celsius and 290 degrees Celsius over this period of at least 3 months or at least 6 months or at least 1 year. In some embodiments, ‘low temperature pyrolysis’ occurs between 280 degrees Celsius and 290 degrees Celsius over this period of at least 3 months or at least 6 months or at least 1 year. In this temperature range, pyrolysis proceeds quickly enough to be feasible, while favoring formation of easier-to-hydrotreat species.

For the present disclosure, a process that is ‘self-sufficient with respect to hydrogen gas” consumes only H₂ gas formed as a reaction product of the pyrolysis itself, and does not include hydrogen gas derived from steam methane reforming of the pyrolysis gases.

For the present disclosure, ‘low severity’ hydrotreating conditions are characterized by (i) a maximum temperature of at most 350 degrees Celsius or at most 340 degrees Celsius or at most 330 degrees Celsius; and (ii) a maximum pressure is at most 120 atmospheres (atm) or at most 110 atm or at most 100 atm or at most 90 atm or at most 80 atm or at most 70 atm.

For the present disclosure, unless otherwise specified, when a feature related to a portion or a fraction of a composition (e.g. of an oil) is disclosed, this refers is by weight (e.g. wt/wt %) and not by mole or by volume. For the present disclosure, unless otherwise specified concentrations and ratios therebetween are by weight (e.g. wt/wt %) and not by mole or by volume.

Embodiments of the present invention relate to a multi-stage technique for producing a light, sweet synthetic crude oil having a sulfur content of at most 1% wt/wt and a nitrogen content of at most 0.2% wt/wt from sulfur-rich type IIs kerogen without relying on external sources of hydrogen gas. Experiments conducted by the present inventors indicated that after generating hydrocarbon pyrolysis fluids by pyrolyzing type IIs kerogen having a sulfur content of at least 8% wt/wt (or higher—for example, at least 10% wt/wt or at least 12% wt/wt) nitrogen content primarily at low temperatures of at most 350° C., it is possible to hydrotreat the hydrocarbon pyrolysis fluids into a light, sweet synthetic crude oil: (i) under low severity conditions of at most 120 atmospheres and at most 350 degrees Celsius; and (ii) in a manner where at most only 180 Nm³m⁻³ of hydrogen gas is consumed in the hydrotreating process.

As a result of the surprisingly low consumption of hydrogen gas, it is possible to perform the hydrotreating process without requiring external sources of hydrogen gas. Instead, it is possible to rely only upon the quantities of pyrolysis hydrogen gas generated by the pyrolysis of the type IIs kerogen, without any need to steam reform pyrolysis methane gas and without any need to construct and maintain a hydrogen gas pipeline. One characteristic of the process is that it is self-sufficient with respect to hydrogen gas.

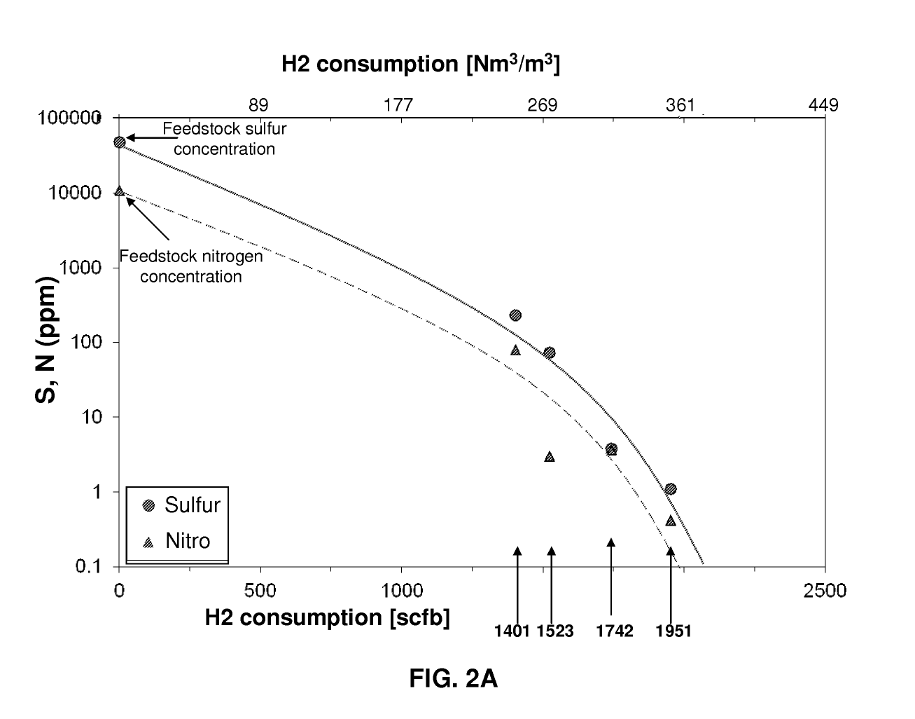

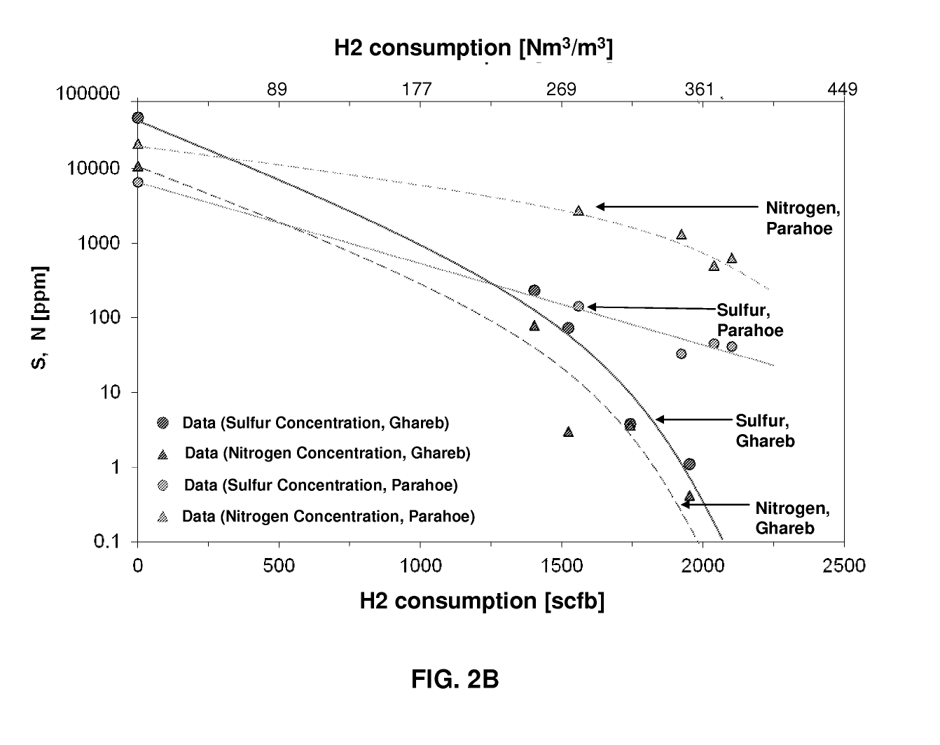

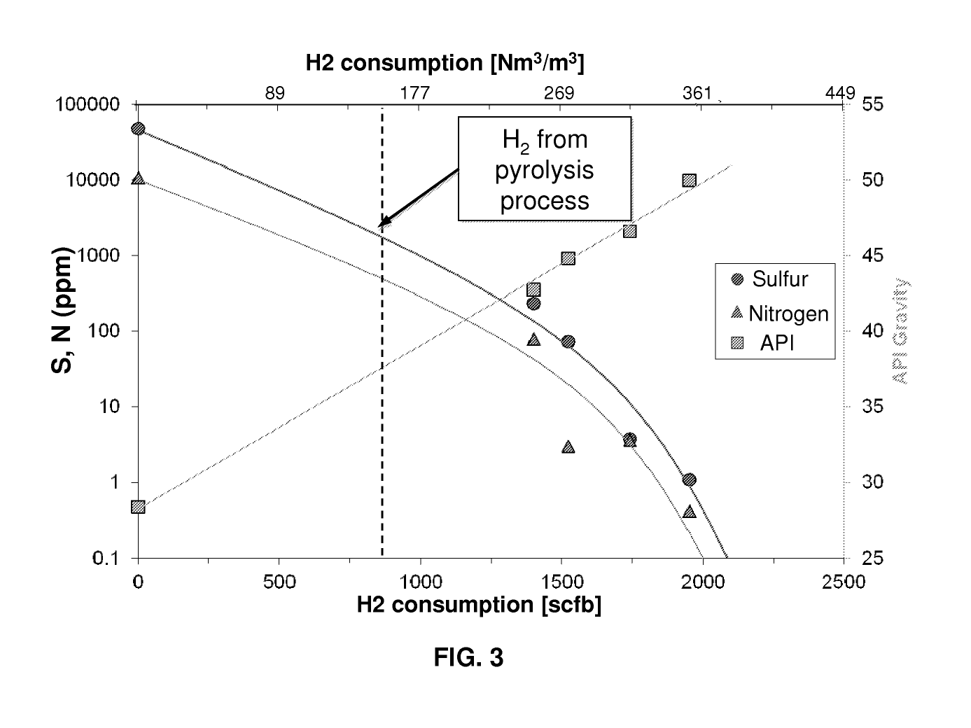

FIGS. 2A, 2B, and 3 illustrate sulfur and nitrogen concentration within a synthetic oil as a function of amount of hydrogen gas consumed according to experiments conducted on ‘hydrocarbon pyrolysis liquid feedstock’ obtained by pyrolyzing cored samples of kerogenous chalk from the Ghareb formation (see examples below). This ‘hydrocarbon pyrolysis liquid feedstock’ includes significant amounts of pyrolysis liquids formed at relatively low temperatures.

As illustrated in FIG. 2A, feedstock respectively had sulfur and nitrogen concentrations of about 50,000 ppm and 10,000 ppm. Experimental results are presented in FIG. 2A for four hydrotreatment experiments respectively characterized by hydrogen gas consumptions of (i) 1401 standard cu. ft. per barrel (see ‘Case 5’ of in examples below), (ii) 1523 standard cu. ft. per barrel (see ‘Case 4’ of in examples below), (iii) 1742 standard cu. ft. per barrel (see ‘Case 1’ of in examples below), and (iv) 1951 standard cu. ft. per barrel (see ‘Case 3’ of in examples below). As discussed below in examples below and as illustrated in FIG. 2A, (i) in Case 5 the sulfur concentration was reduced to 236 ppm and the nitrogen concentration was reduced to 80.1 ppm; (iii) in Case 4 the sulfur concentration was reduced to 73.1 ppm and the nitrogen concentration was reduced to 3.05 ppm; (iv) in Case 1 the sulfur concentration was reduced to 3.8 ppm and the nitrogen concentration was reduced to 0.82 ppm; (iv) in Case 3 the sulfur concentration was reduced to 1.11 ppm and the nitrogen concentration was reduced to 0.42 ppm.

The concentrations of sulfur and nitrogen for these four experiments together with the feedstock values were curve-fit as a function of hydrogen gas consumption—the results are presented in FIG. 2A.

In FIG. 2B, the results of FIG. 2A were compared to prior art ‘Parahoe’ data for hydrocarbon pyrolysis liquids derived from pyrolyzing type I Green River oil shale in a standard retort process. In particular, the prior art ‘Parahoe’ data describes sulfur and nitrogen concentration in hydrotreated pyrolysis liquids as a function of hydrogen gas consumption.

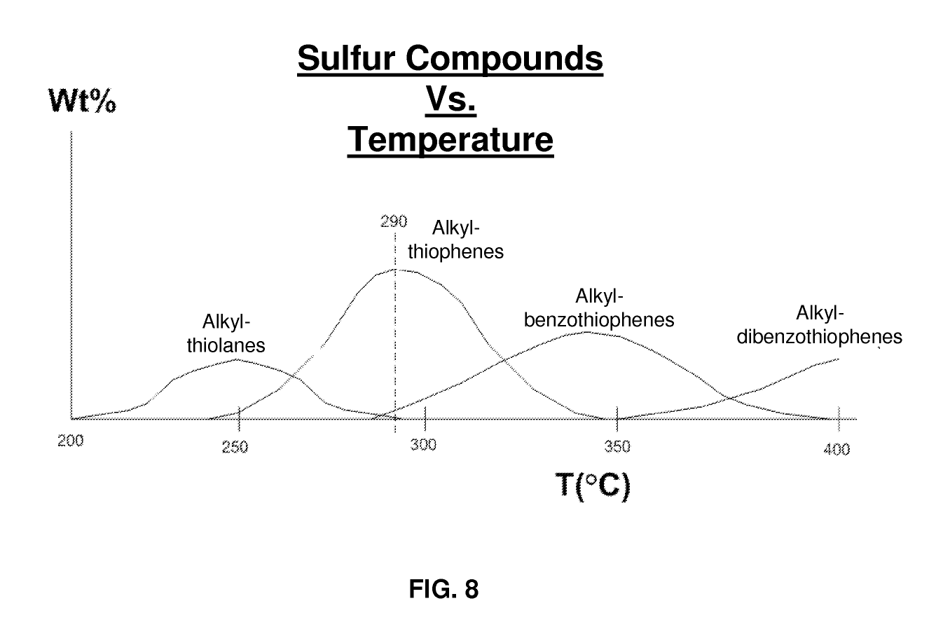

As illustrated in FIG. 2B, an absolute value of a downward slope representing the reduction of concentration of nitrogen or sulfur as a function of hydrogen gas consumption is greater for the Ghareb blend including pyrolysis liquids formed by the presently-disclosed low-temperature slow pyrolysis of type IIs kerogen. As will be discussed below with reference to FIG. 8, this indicates relatively high concentrations, within the pyrolysis formation liquids, of easier-to-hydrotreat single-ring and low molecular weight heterocyclic species.

One salient feature of any pyrolysis process is that hydrogen gase is produced along with hydrocarbon liquids and gases. For the presently-disclosed pyrolysis process of the Ghareb formation, it is believed that the pyrolysis process yields about 900 standard cu. ft. of hydrogen gas per barrel of hydrocarbon pyrolysis liquid—in metric units this is approximately 160 Nm³/m³. As illustrated in FIG. 3, this amount of hydrogen gas is sufficient to respectively reduce sulfur and nitrogen concentrations within the hydrotreated synthetic hydrocarbon pyrolysis liquids to about 1200 ppm and 800 ppm.

Thus, the data of FIG. 3 indicates that it is possible to reduce the sulfur and nitrogen concentrations in hydrocarbon liquid feedstock provided by the presently-disclosed low-temperature pyrolysis process (i.e. applied to type IIs kerogen) in a manner that is ‘self-sufficient’ with respect to hydrogen gas. The data of FIG. 3 relates to a blend of hydrocarbon liquids formed at multiple temperatures including some liquids formed at the ‘low temperatures’ and some formed at higher temperatures. It is believed that even better results are achievable with a sample of hydrocarbon liquids derived only from low-temperature pyrolysis of type IIs kerogen.

Although the present invention is not limited to in situ pyrolysis practices, in some preferred embodiments, the pyrolysis of the type IIs kerogen is carried out in situ. As discussed above with reference to FIG. 3, in some embodiments, the hydrotreating is self-sufficient with respect to hydrogen gas.

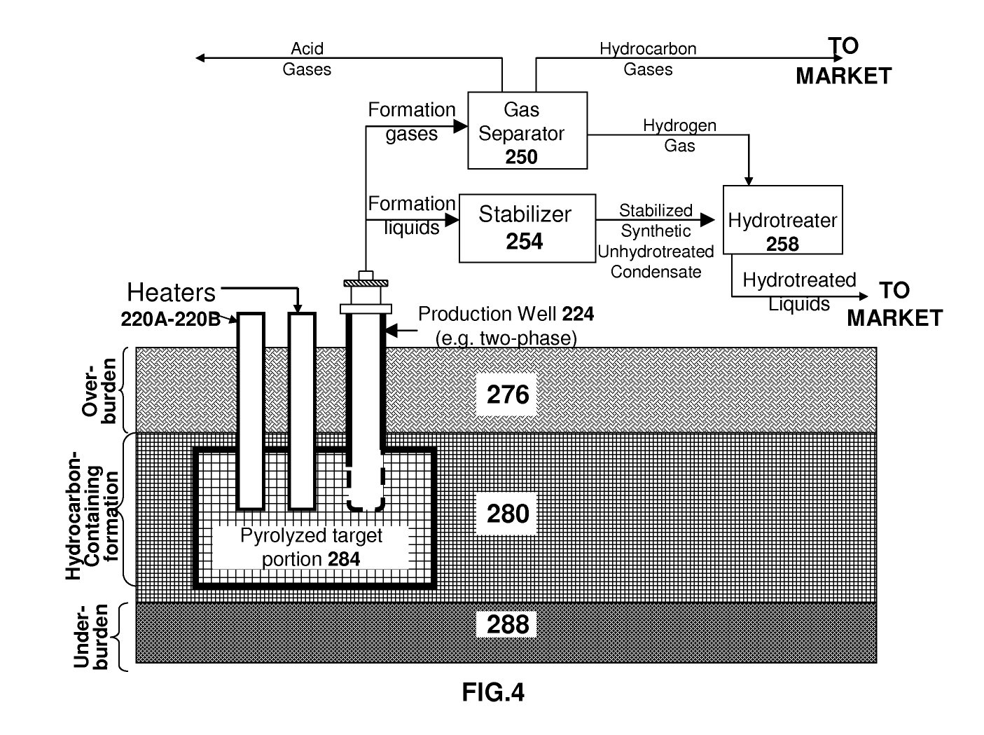

FIG. 4 is a schematic diagram of a ‘hydrogen-gas self-sufficient’ system for in-situ thermal treatment of a hydrocarbon-containing subsurface formation 280 located below an overburden 276 and above an underburden 288. In the situation depicted in FIG. 4, it is possible to hydrotreat formation liquids without relying on any external source of hydrogen. All hydrogen for the hydrotreating process is provided by the in situ pyrolysis of subsurface kerogen as shown in FIG. 4.

A plurality of heaters 220 (e.g. electrical heaters or molten salt heaters) are deployed within a target portion 284 of the hydrocarbon-containing subsurface formation 280. Thermal energy is transferred from the heaters 220 to the target portion 284 so as to heat the target portion 284 and to eventually pyrolyze kerogen therein. Formation gases and liquids are recovered via production well 224 so that (i) pyrolysis formation gases comprising acid gases, hydrogen gas, and hydrocarbon gases are received into gas separator 250 and (ii) hydrocarbon pyrolysis formation gases are received into stabilizer 254 and eventually pass into hydrotreater 258.

FIG. 4, as drawn, shows that all hydrogen gas input into hydrotreater 258 is pyrolysis formation gas.

As noted above, the data of FIGS. 2-3 is taken from experiments described in examples below. In particular, in ‘Case 5’ of examples below, the hydrotreatment is carried out at 349 degrees Celsius and 102 atmospheres. It is noted that case 5 refers to pyrolysis of a blend of hydrocarbon formation fluids including significant quantities of pyrolysis fluids formed at temperatures above 325 degrees when the fluids include higher concentrations of hard-to-hydrotreat species than what would be found in pyrolysis liquids formed at low pyrolysis temperatures due to a volume requirement for testing the hydrotreatment. Therefore, it is believed that the temperature of 349 degrees Celsius and pressure of 102 atmospheres is an upper bound, and that better results are attainable when pyrolysis is carried out primarily at low temperatures. Furthermore, in ‘Case 5’ of examples below, the final sulfur and nitrogen concentrations are respectively 236 ppm and 80.1 ppm. In the event that the target final concentrations are higher (e.g. a target sulfur concentration of 1,000 ppm and a target nitrogen concentration of 200 ppm), it is, once again, believed that even lower pressures than 102 atm and even lower temperatures than 349 degrees Celsius may be used.

As noted above, for the present disclosure, ‘low severity’ hydrotreating conditions are characterized by (i) a maximum temperature of at most 350 degrees Celsius or at most 340 degrees Celsius or at most 330 degrees Celsius; and (ii) a maximum pressure is at most 120 atmospheres (atm) or at most 110 atm or at most 100 atm or at most 90 atm or at most 80 atm or at most 70 atm.

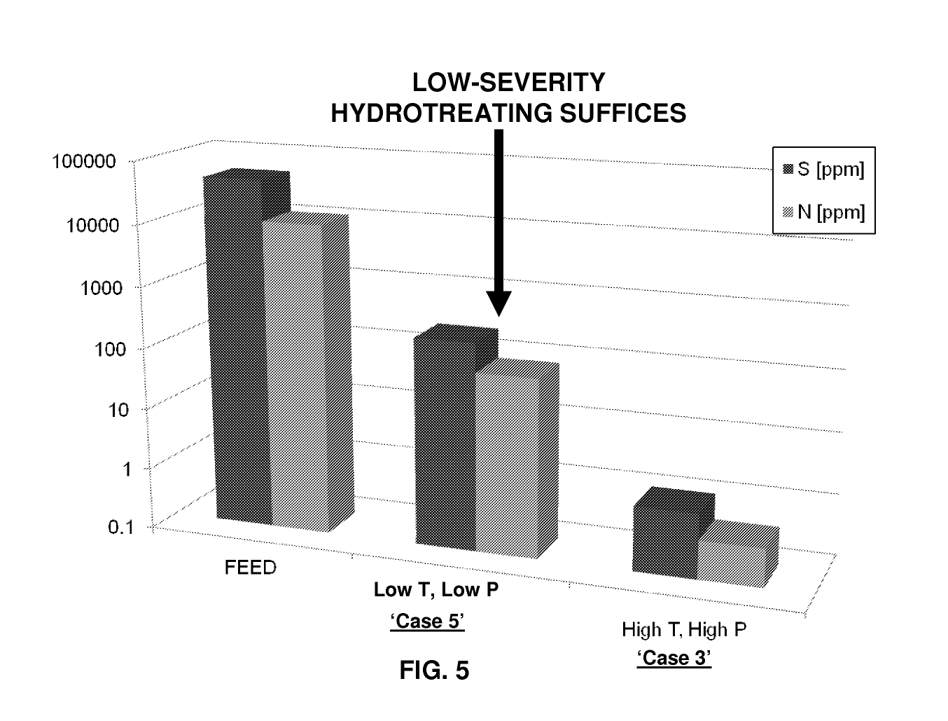

FIG. 5 illustrates nitrogen and sulfur values for the FEED (i.e. where the curves of FIG. 2A intercept the y-axis), ‘Case 5’ labeled as “Low T, Low P” (middle bars of FIG. 5), and ‘Case 3’ labeled as ‘High T, High P.’

The present inventors are now disclosing, for the first time, that surprisingly low-severity hydrotreating of pyrolysis liquids derived from sulfur-rich type IIs kerogen is sufficient for generating a low-sulfur and low-nitrogen hydrotreated oil.

As a result of the surprisingly low levels of nitrogen and sulfur obtainable at these low pressures and temperatures, it is possible to reduce the capital cost required to hydrotreat the pyrolysis fluids. In particular, it is possible to employ vessels constructed from carbon steel or other similar materials that are designed to operate only at pressures of up to 120 atmospheres, rather than relying on more expensive stainless steel vessels that are typically required at higher pressures.

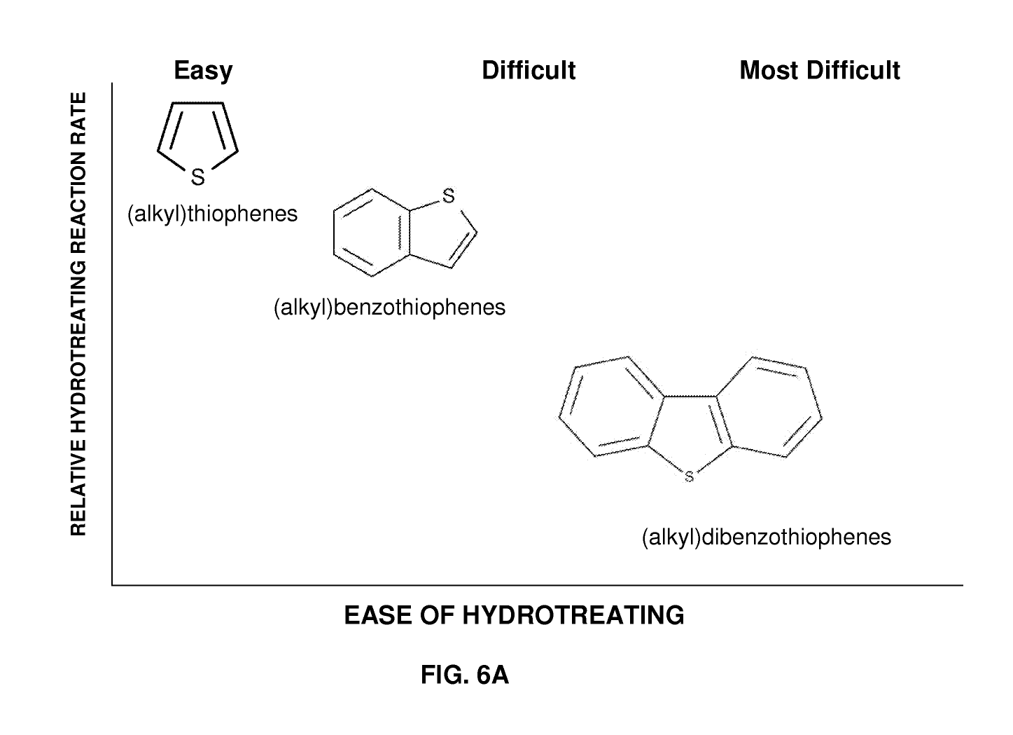

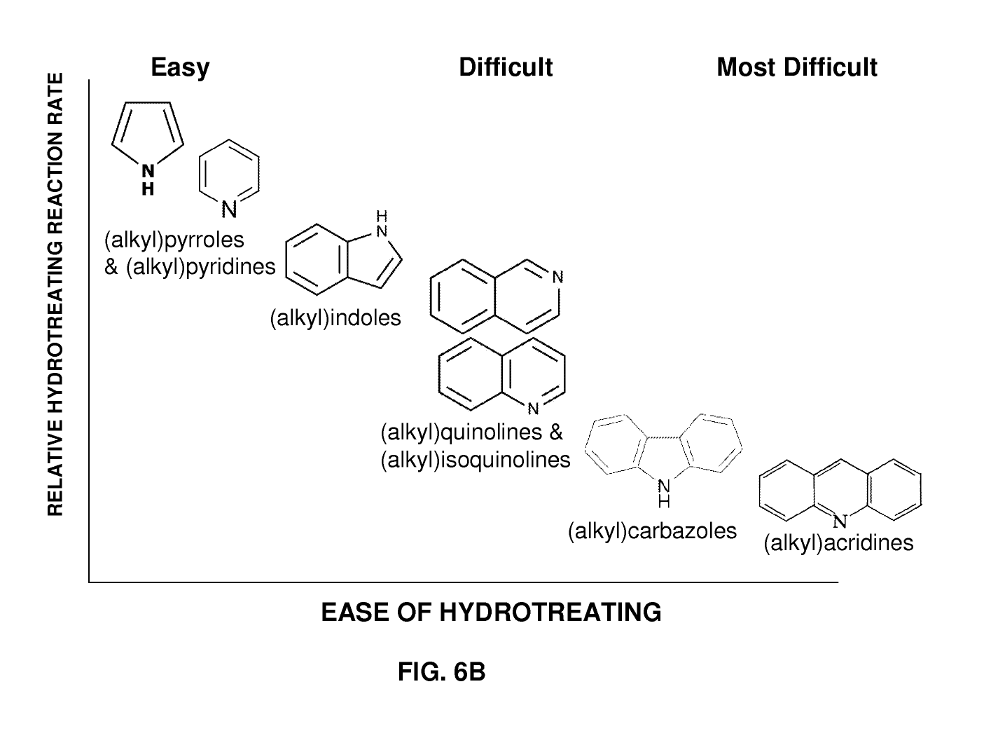

It is believed that the reason that the presently-disclosed hydrocarbon pyrolysis formation liquids are surprisingly easy to hydrotreat is that they are formed mostly at low temperatures. These low temperatures favor formation of easier-to-hydrotreat species such as single-ring heterocyclic compounds, for example, a single-ring heterocyclic aromatic compound of relatively low molecular weight. FIGS. 6A-6B illustrate various sulfur heterocyclics ranked as a function of relative hydrotreating reaction rate. FIG. 6A relates to sulfur species while FIG. 6B relates to nitrogen species. In FIG. 6A, the easiest species to hydrotreat are the alkylthiophenes (single-ringed species) while the hardest species are the alkyldibenzothiophenes (triple-ringed species). In FIG. 6B, the easiest species to hydrotreat are the alkylpyridines and the alkylpyrroles (both single-ringed species) and while the hardest species are the alkylacridines and alkylcarbozoles (both triple ringed species).

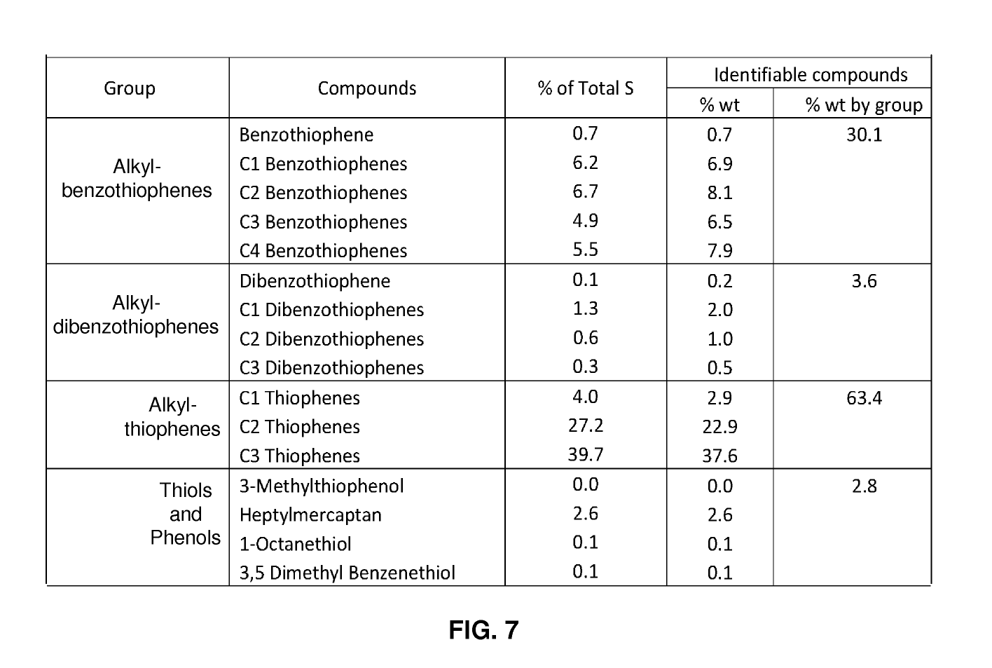

As discussed below in examples below, the hydrocarbon pyrolysis liquids of the ‘blend experiment’ were subjected to speciation analysis. The results are illustrated in FIG. 7 (see example 3). Although FIG. 7 only relates to sulfur species, there is a clear trend of higher concentrations of easier-to-hydrotreat sulfur species. By analogy, in accordance with the results of FIGS. 2-3 indicating effective hydrotreating of nitrogen species with respect to hydrogen consumption, it is believed that similar trends prevail for nitrogen heterocyclics.

FIG. 8 illustrates the wt % of sulfur compounds within pyrolysis formation liquids derived from type IIs kerogen as a function of temperature according to one example. Sulfur compounds within formation fluids generated at very low sub-pyrolysis temperatures are primarily alkylthiolanes. Sulfur compounds within formation fluids generated at low pyrolysis temperatures are primarily alkylthiophenes. Sulfur compounds within formation fluids generated at higher and more conventional pyrolysis temperatures are primarily alkylbenzothiophenes or alkyldibenzothiophenes.

As shown in FIG. 8, a majority, or significant majority, or substantially all sulfur species pyrolysis fluids formed at low pyrolysis temperatures below 290 degrees Celsius, are relatively easy-to-hydrotreat alkylthiophenes.

In the chosen low-pyrolysis temperatures (e.g. between 270 and 290 degrees Celsius), the easier to hydrotreat thiophenes are produced in greatest quantity. This temperature range captures only the beginning of benzothiophene formation, and the tail-end of thiolane production. The chosen temperature range is selective against the harder to hydrotreat dibenzothiophenes.

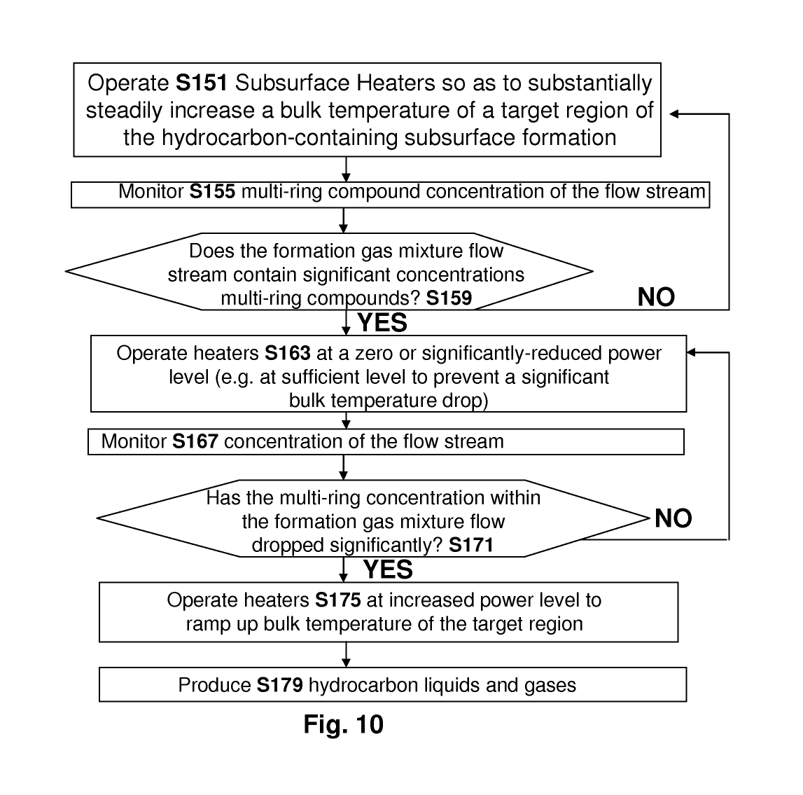

As discussed below in examples below, the present inventors have conducted kinetics experiments related to kerogen pyrolysis kinetics. Results are presented in FIG. 10. In particular, in FIG. 10 the pyrolysis kinetics of type IIs kerogen is compared to that of type I Green River kerogen. From FIG. 10, one may conclude that at 290 degrees Celsius, the pyrolysis of type IIs kerogen is surprisingly about two orders of magnitude faster than pyrolysis of type I Green River kerogen.

Economic Advantages

As noted above, one advantage of the presently-disclosed synthetic oil derived from pyrolysis of type IIs kerogen is the ability to pyrolyze in a less sturdy but less expensive hydrotreating vessel rated to only low intensity operating conditions.

An additional advantage is the low metal content of the hydrocarbon pyrolysis liquids, discussed below in examples below. By pyrolyzing kerogen primarily at low pyrolysis temperatures, it is possible to obtain pyrolysis liquids having a lower concentration of metal contaminants than would be otherwise possible. In particular, it is believed that metals are primarily bound up in the surrounding matrix, and are less likely to be removed from this matrix to enter the pyrolysis liquids at lower temperatures.

This is extremely advantageous, since metal-free feedstock is typically much less expensive to hydrotreat than feedstock containing significant quantities of metal, since metals often poison the catalysts used to hydrotreat the feedstock. Furthermore, this obviates the need to use expensive demetalization guard beds to pretreat feedstock in refineries.

In some embodiments, the pyrolyzing of the sulfur-rich type IIs kerogen is performed at relatively low pyrolysis temperatures that do not exceed 290 degrees Celsius. For example, a majority (or significant) majority of the sulfur-rich type IIs kerogen may be pyrolyzed at the low pyrolysis temperatures.

Alternatively or additionally, it is possible to collect hydrocarbon pyrolysis fluids formed at the lower temperatures and keep these low-temperature pyrolysis fluids separate from hydrocarbon pyrolysis fluids formed at higher temperatures—i.e. preventing mixing therebetween.

Features Related to Hydotreating

A guard bed of appropriate demetalization catalyst is not needed to remove any metal ions considered to interfere with the catalysts of hydrotreating as the pyrolysis process as described above produces a hydrocarbon pyrolysis liquid that is contaminant metal-free.

The hydrotreating is preferably performed in the presence of hydrogen and a catalyst. Which catalyst can be chosen from those known to one skilled in the art as being suitable for this reaction. Catalysts for use in this step typically comprise an acidic functionality and a hydrogenation-dehydrogenation functionality. Preferred acidic functionalities are refractory metal oxide carriers. Suitable carrier materials include silica, alumina, silica-alumina, zirconia, titania and mixtures thereof. Preferred carrier materials for inclusion in the catalyst for use in the process of this invention are silica, alumina and silica-alumina. Preferred hydrogenation-dehydrogenation functionalities are Group VIII non-noble metals, for example iron, nickel and cobalt which non-noble metals may or may not be combined with a Group IVB metal, for example W or Mo, oxide promoters. The catalyst may comprise the hydrogenation/dehydrogenation metal active component in an amount of from 0.005 to 5 parts by weight, preferably from 0.02 to 2 parts by weight, per 100 parts by weight of carrier material. A particularly preferred catalyst comprises an alloy of Nickel and Molybdenum and/or Cobalt and molybdenum on an alumina carrier. If desired, applying a halogen moiety, in particular fluorine, or a phosphorous moiety to the carrier, may enhance the acidity of the catalyst carrier. The catalyst bed does not need protection by a guard bed against potential fouling due to particulates, asphaltenes, and/or metals present in the feed.

The sulfur-sulfur bonds in the kerogenous organic material break in the low temperature regime and the C—C bonds break in the high temperature regime. The resultant pyrolysis product shows greater benefit than expected. The Applicants believe that this is due to free radical formation, which initiates carbon-carbon bond cleavage catalyzing the further pyrolysis of the remaining kerogenous material.

### EXAMPLES

The above description is not intended to limit the claimed invention in any manner; furthermore, the discussed combination of features might not be absolutely necessary for the inventive solution.

The present invention will be further illustrated in the following examples. However it is to be understood that these examples are for illustrative purposes only, and should not be used to limit the scope of the present invention in any manner

### Example 1

### Type IIs Kerogen

An 8.6 cm diameter (3.4 inch) PQ core sample of type IIs kerogen was cored from an oil shale with the following petrophysical properties: porosity of 35-40%, permeability of 0.05-0.2 mD, and total organic carbon (TOC) of 14-18 wt %. A Fischer Assay in which 100 grams of the raw rock were crushed to <2.38 mm pieces, heated to 500° C. at a rate of 120° C./min, and held at that temperature for 40 minutes was performed. The distilled vapors of oil, gas, and water are condensed and centrifuged to assess the amount of oil yielded by the rock sample. Fischer Assay results for the oil shale is 24-29 gal/ton. Elemental analysis of a specific raw rock sample from the Ghareb formation, a bituminous and kerogenous chalk, gave the kerogen composition presented in the table below.

Kerogen composition in wt %

| | |
|---|---|
| Carbon | 65.30 |
| Hydrogen | 7.95 |
| Nitrogen | 2.15 |
| Oxygen | 14.36 |
| Sulfur | 9.80 |

### Example 2

### In Situ Pyrolysis of Samples of Type IIs Kerogenous Chalk

First, Fischer Assay numbers were collected from the samples, then the API gravity of the Fischer Assay oil was measured. All measurements were reported on a dry weight basis. Samples of type IIs kerogen-bearing oil shale was crushed to 1-5 mm pieces and packed into a retort. The retort vessel chosen was a pressure-regulated semi-batch pyrolysis reactor.

The weight change of the retort system was tared, then measured every 1.5 hours. Flow measurements were also made. A gas chromatograph (GC) was run every 1.5 hours, timed to be coincident with the weight and flow measurements, to identify compounds in the pyrolysis fluids. The H₂S level was measured with a Draeger tube, a colorimetric gas detection technology, downstream of the reactor and GC.

Approximately 30 experimental runs were conducted. The temperature ramps and the constant pressure for the system during a single run were varied from one run to another according to the inventors' specifications. Temperature ramps ranged from 1-4° C./hr starting from ambient temperature increasing to no higher than 430° C. with a back pressure on the system held constant at a pressure chosen from between 0-150 psig.

For example, an experiment held at 150 psig for the duration of the experiment and with a maximum temperature of 430° C., with a 1-2° C. rate was conducted as follows. The reactor/retort was heated at a rate of 1° C./min on the skin temperature up to 175° C. and held at that temperature for 1 hour minimum. From 175° C., the temperature was increased by 2° C./hr on the skin temperature until the skin temperature reached 200° C. The retort was held at this temperature until the center shale temperature reached 200° C. (Free water boils at 185° C., so the reactor pressure was carefully adjusted and from this point on, the top head heater of the retort was held at a 5-10° C. hotter temperature in order to prevent water vapors from condensing on the head.) A water product receiver was weighed every 3 hours until all of the water was removed from the retort system. Beyond 200° C., heating continued at 2° C./hr on the skin temperature. Gas was collected on another product receiver, which was also tared and weighed. When the system reached 300° C., the weight and volume of oil and water removed are measured. Oil and water were held in reserve in a sealed refrigerated container. Product collection continued with a separate product receiver. When the mid-retort shale temperature reached 430° C., the temperature was held for at least 8 hours with only the head temperature held 10° C. higher. When the N₂ content reached 80% according to the GC analysis, all retort heaters were turned off. As soon as the pressure measured decreased, purging with N₂ or Argon, allowed for obtaining the final oil product collection. Retort was checked for residual oil. Product samples were stored in a sealed refrigerated container. The spent shale was weighed and used to perform three Fischer Assays to compare with the initial Fischer Assay.

This procedure was performed in the same manner for samples at other pressures and temperature ramps. The samples collected from this experiment were also subjected to elemental analysis and will be discussed further below.

### Example 3

### Characteristics of Pyrolysis Liquids (Hydrotreating Experiment Feedstock)

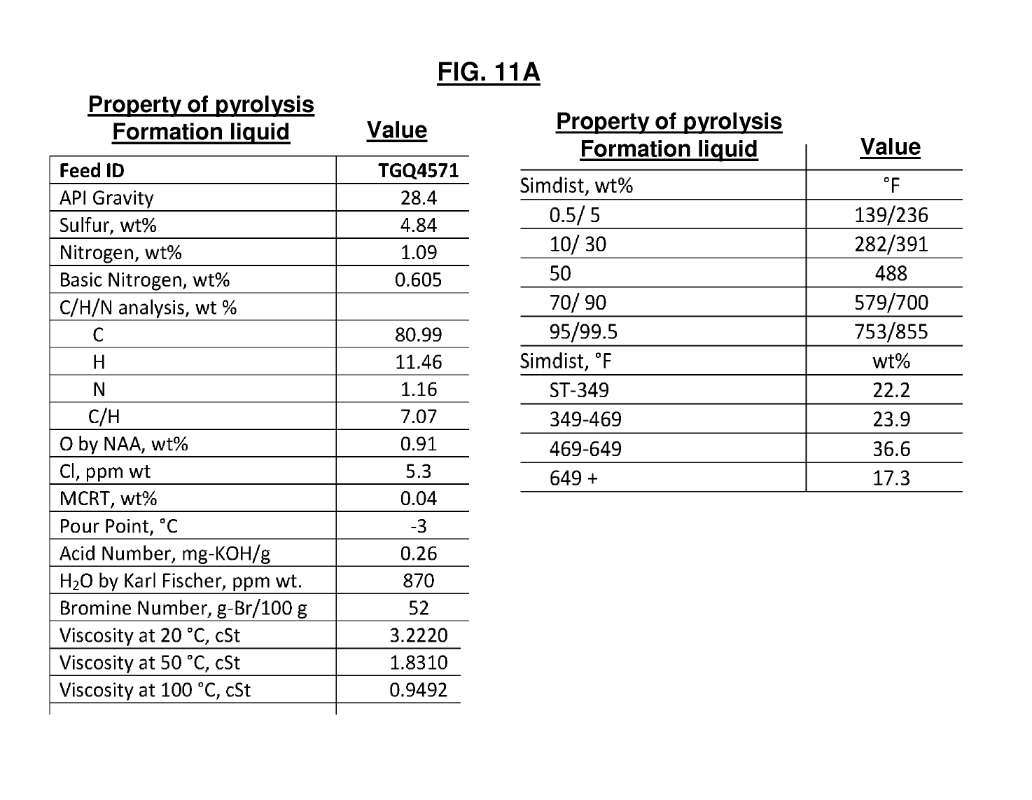

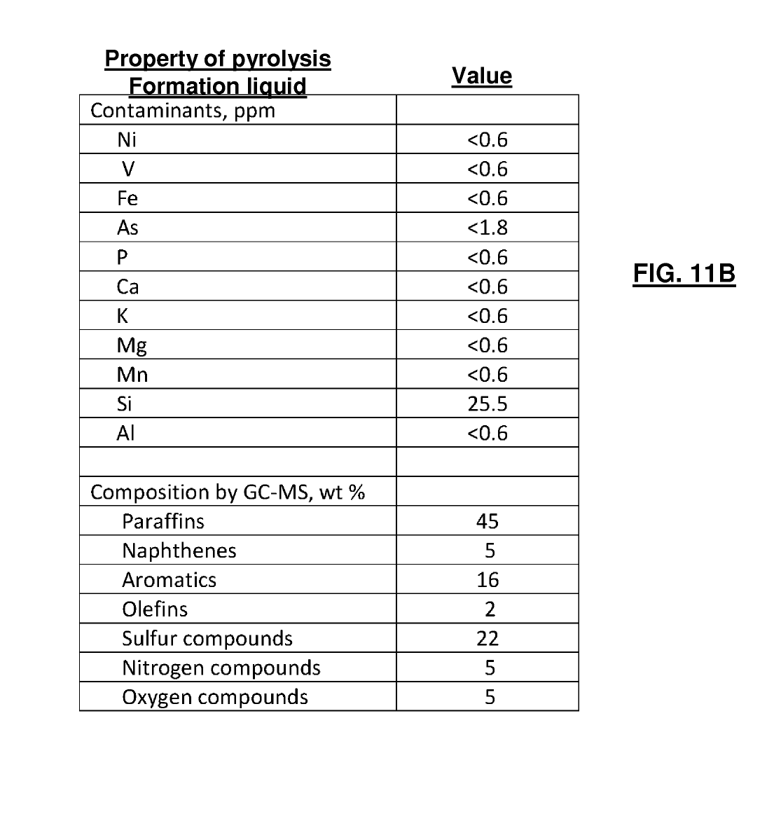

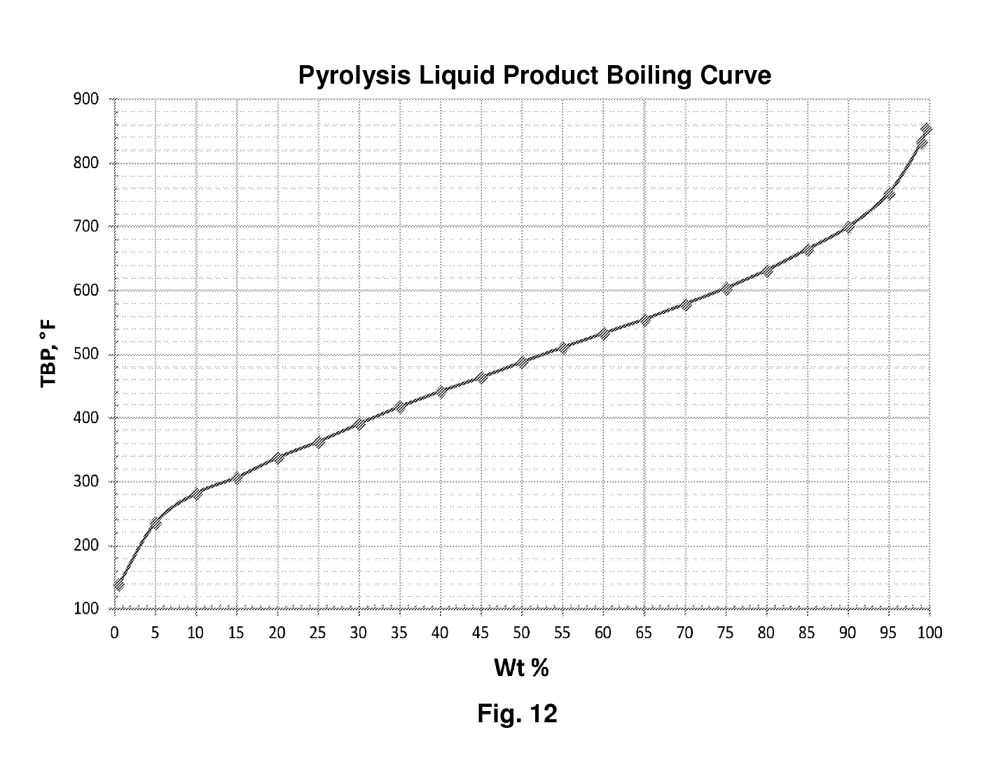

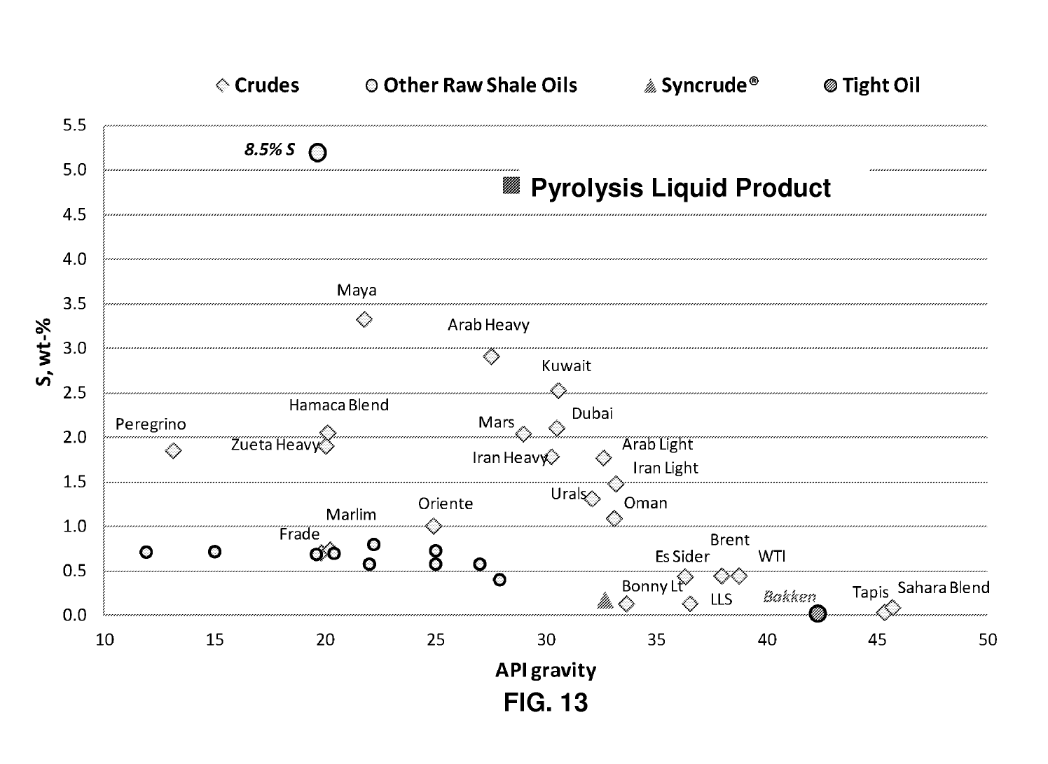

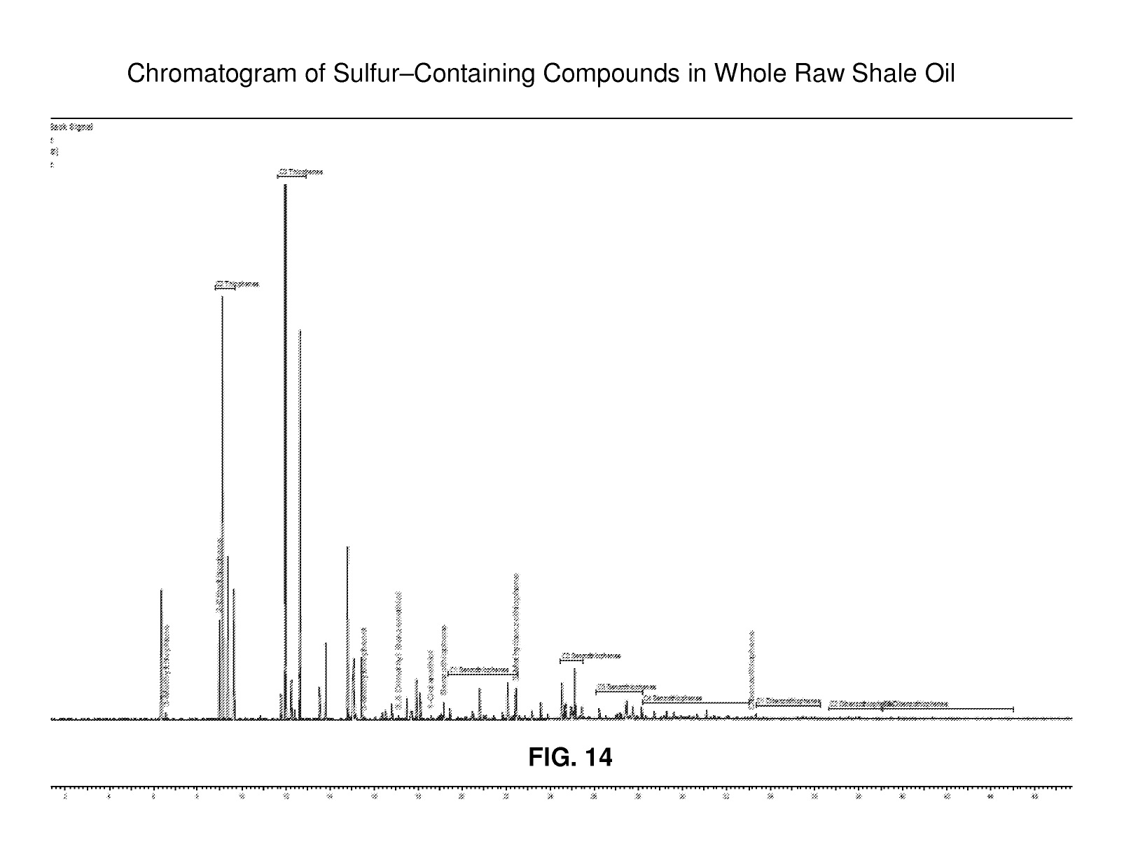

The pyrolysis liquid products from the various temperatures and pressures were blended to create a more accurate representation of product in the field. The properties of pyrolysis liquids blended from the aliquots collected in the procedure described above are given in FIGS. 11A and 11B. A boiling curve derived from simulated distillation data is shown in FIG. 12. The material was relatively light and liquid at room temperature. In spite of its relatively low end point, it contains very high concentrations of sulfur and nitrogen (4.84 and 1.09 wt %, respectively). This is contrary to what is frequently seen in petroleum feedstocks and in several other shale oils, as clearly shown in FIG. 13. The elevated bromine number may indicate a high degree of unsaturation, but could also be, at least in part, the result of interference by phenolic compounds, which react toward bromine in the same way as olefinic double bonds. The contaminant of greatest concern was C1, present at 5 ppm. Additional characterization tests were run on the hydrocarbon pyrolysis liquid product, attempting to accurately identify the main types of compounds present. GCxGC data (not shown here) qualitatively showed that saturates are most abundant. Sulfur-containing compounds, such as thiophenes, are also very significant. The feed was also characterized by GC-MS to obtain more quantitative composition data. The results are part of FIGS. 11A and 11B. While significant, the concentration of aromatic hydrocarbon compounds was relatively low compared with values commonly observed in other shale oils and may be related to the process used to generate the hydrocarbon pyrolysis liquid product.

Other general observations regarding the properties of the hydrocarbon pyrolysis liquid product, compared with other shale oils, can be summarized in the three points as follows: a) the density, boiling end point and pour point are relatively low, characteristic of an overall light material, b) metal contaminants were uncommonly low, (Low levels of contaminants generally result in lower complexity and lower cost of upgrading the oil), and c) the carbon:hydrogen ratio was relatively low, which agreed with the low aromatic content.

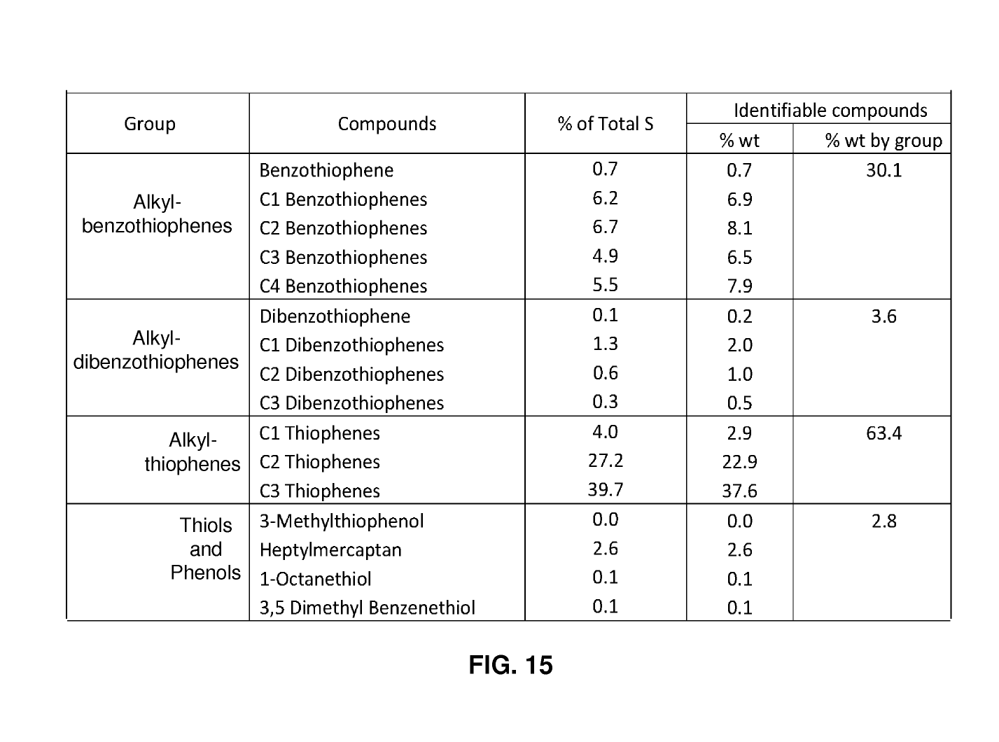

Chromatography tests using a Pulse Flame Photometric Detector (PFPD) optimized for sulfur detection were performed to determine the identity of the sulfur-containing compounds in the hydrocarbon pyrolysis oil product. The concentrations of identifiable compounds derived from GC peak areas are summarized in FIG. 15. The majority of the sulfur compounds are thiophenes (including alkyl thiophenes). Benzothiophenes are the second most significant group. Most of these compounds are relatively light, with molecules containing between 5 and 12 carbon atoms. Upon hydrotreatment their boiling points are largely in the naphtha and jet fuel range. These data had significant implication in the interpretation of the hydroprocessing results.

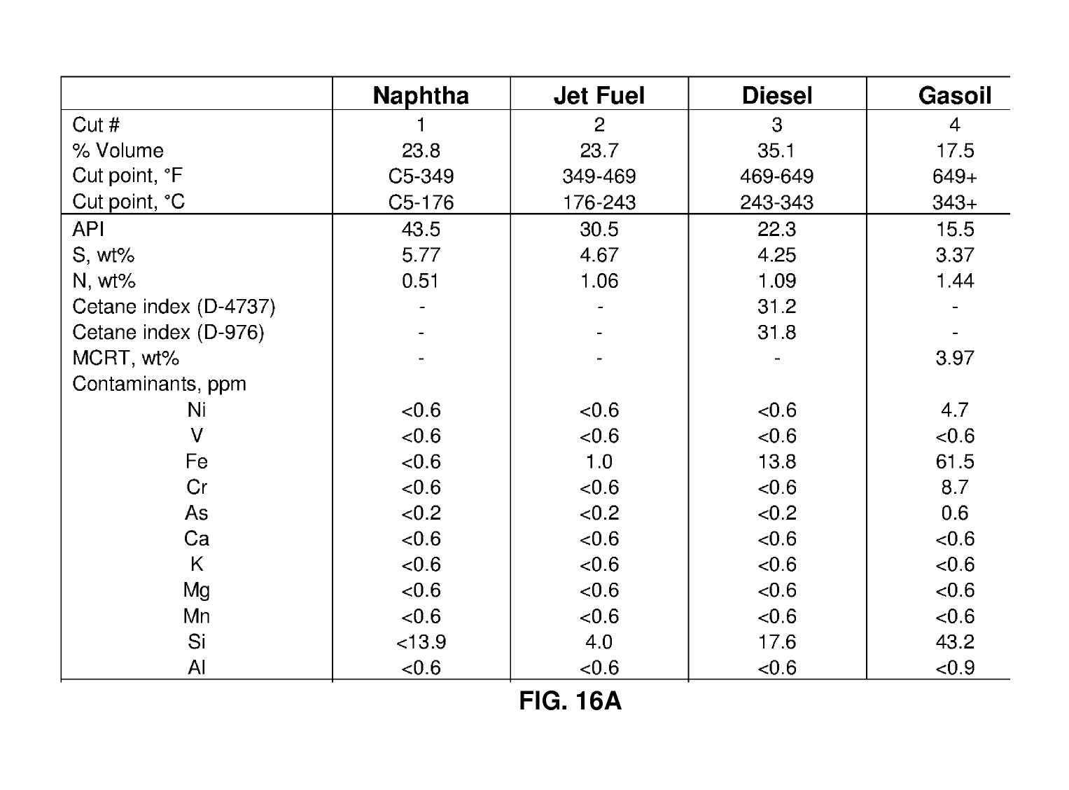

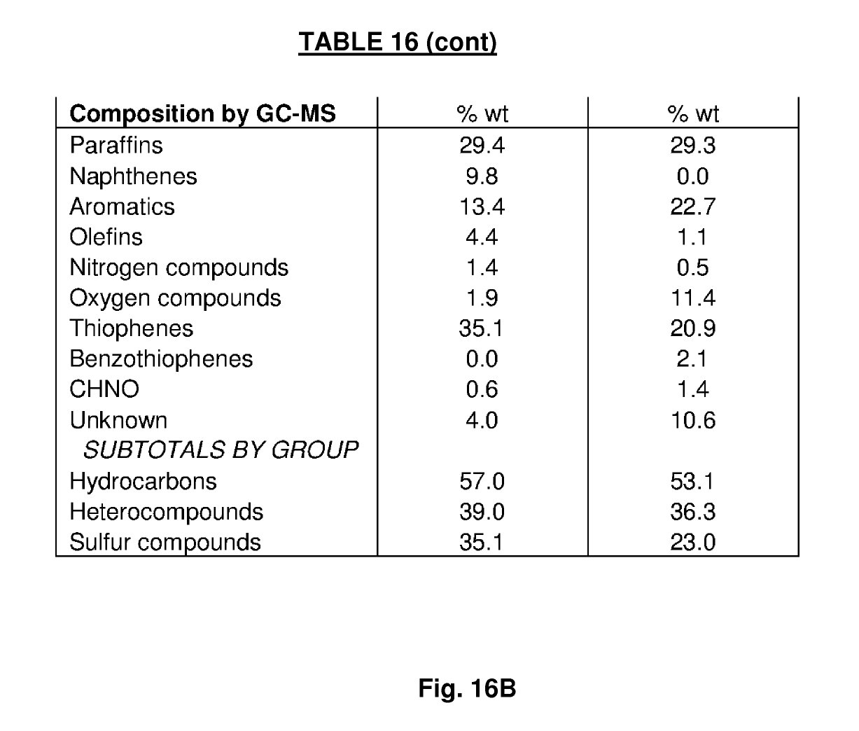

FIG. 16A and FIG. 16B list properties of the individual cuts obtained by distillation from the pyrolysis liquid product. The concentrations of sulfur and nitrogen are relatively high in all the fractions, and unlike what is normally seen in petroleum, where lighter fractions tend to have lower concentrations of heteroatoms. It was decided that the pyrolysis liquid product would be upgraded whole and as a blend of the various temperature and pressure experiments, because all individual fractions require hydrotreatment to be converted into either finished products or synthetic crude oil and there was too little volume to hydrotreat each distillation fraction or each set of parameters individually.

High concentrations of Fe, Ni and Cr were measured in the gasoil fraction (62, 5 and 9 ppm respectively). These values appear artificially high and caused most likely by interaction between the pyrolysis liquid product and the type-304 stainless steel column used for fractionation at the high temperature required to separate this cut. The pyrolysis liquid product used for the hydroprocessing runs in the following Example was not at risk of this contamination, since no fractionation was performed prior to the tests.

### Example 4

### Methodology of Preparation of Sweet Synthetic Crude Oil (Hydrocarbon Pyrolysis Liquid Blend)

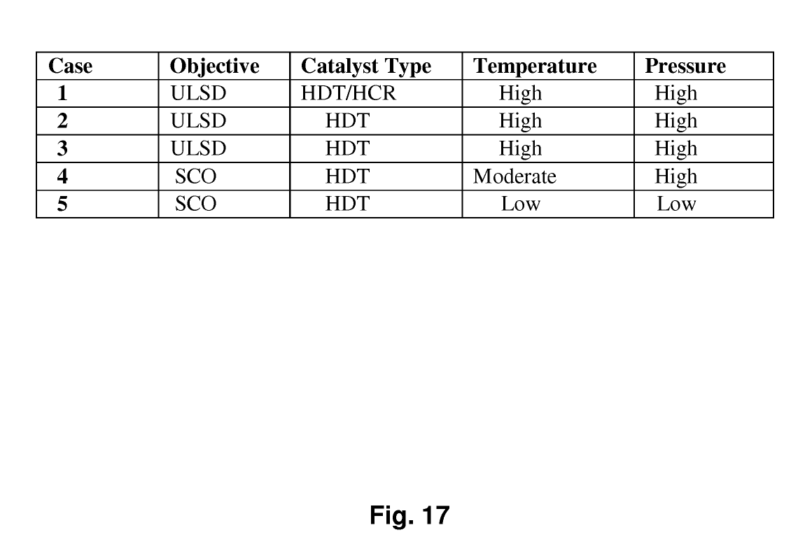

Upgrading studies focused on two main scenarios: a) full upgrading into marketable products with generation of ultra-low sulfur diesel (ULSD) as the main objective, and b) partial upgrading into synthetic crude oil (SCO), suitable for further processing at external conventional oil refineries. To fulfill objectives a) and b), different catalyst combinations and process conditions were tested, resulting in a total of five cases, as detailed in FIG. 17. Here, HDT stands for hydrotreating catalyst and HCR stands for hydrocracking catalyst.

For characterization purposes, the pyrolysis liquid product was sampled whole and also after fractionating into the following four cuts: a) Naphtha (C5-349° F. or C5-176° C.), b) Jet fuel (349-469° F. or 176-243° C.), c) Diesel (469-649° F. or 243-343° C.), d) Gasoil (649° F.+ or 343° C.+). The same cut points were used to distill and characterize the products from the upgrading tests.

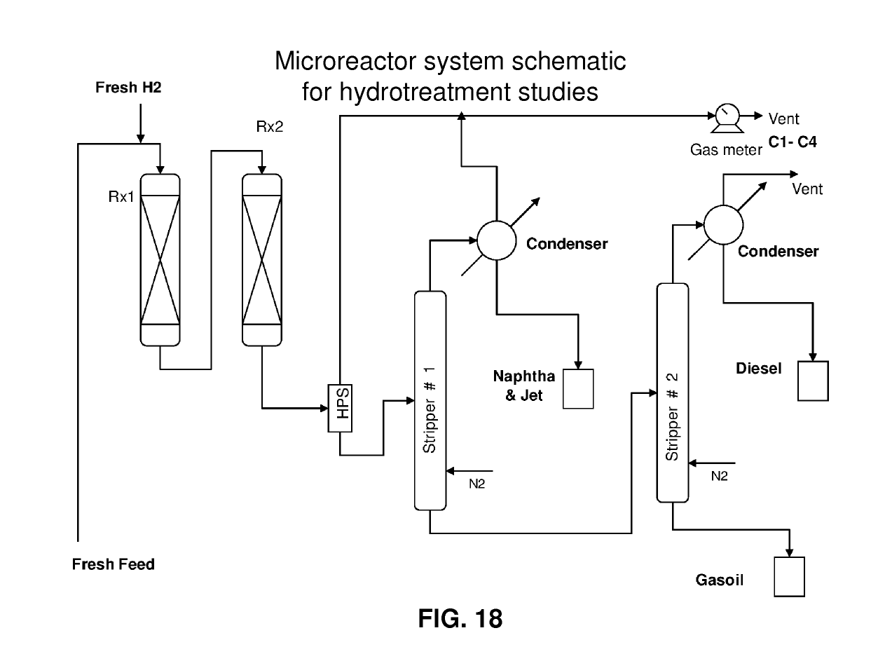

The upgrading pilot tests were performed in a small downflow fixed bed reactor (micro unit) and the results reflect only start-of-run catalyst activity. The contaminant of greatest concern was C1, present at 5 ppm. While hydrotreating catalysts and desalting procedures can generally remove C1 from the feed, byproducts of this reaction, such as HCl, may cause corrosion problems to stainless steel upgrading equipment. For this reason, the hydroprocessing tests were run on a micro unit reactor, shown in FIG. 18, which is built entirely of corrosion-resistant Monel and Hastelloy.

### A. Micro Unit Configuration

The same micro unit was used for all hydroprocessing tests. It consists of two downflow reactors in series. Liquid feed and hydrogen gas are fed in once-through mode. Each reactor is a ⅜″ OD tube (7 mm ID) which can be loaded with up to 10 cc of catalyst. The unit piping includes valves that enable bypassing the second reactor as well as operation of both reactors in series. Each reactor is placed inside a three-zone clamshell electric furnace. Temperatures are read from three skin thermocouples, each placed in the middle of each heated zone. Layers of catalyst are generally loaded in the center of the reactor, so that the entire bed fits within the middle heated zone to ensure uniform temperature across the bed Immediately after leaving the last reactor, the effluent was separated into liquids and non-condensable gases in a high-pressure separator. For this study, when operating in ultra-low sulfur diesel (ULSD) production mode (Cases 1, 2 and 3), the liquid stream flowed through two strippers in series. The strippers were operated to achieve product separation with cut points of 469 and 649° F., respectively. The overhead product of the first stripper was further separated in a condenser into light hydrocarbon gases and light hydrocarbon liquids, the latter corresponding to the combined naphtha and jet fuel products. The bottoms product of the first stripper was fed into the second stripper, where diesel was separated as overhead product and gasoil as bottoms. Off-line distillation was necessary to separate the naphtha from the jet fuel products. Only one stripper was used when operating to produce synthetic crude oil (Cases 4 and 5).

### B. Catalysts

Chevron Lummus Global's commercial hydroprocessing catalysts were used for the upgrading tests, loaded in the micro unit reactors as crushed extrudates of 24-42 mesh size. Only hydrotreating and hydrocracking catalysts are considered active catalysts. Traps and hydrodemetallation (HDM) catalysts are not considered active catalysts and were included in the load simply as precaution for contaminant removal. Space velocity calculations are based only on the volume of active catalysts. Cases 1 and 2 include both hydrotreating and hydrocracking catalysts. Catalyst ICR 250 has mild hydrocracking activity and was included in the load attempting to maximize diesel yield by converting the gasoil-range material in the feed mainly by ring opening. It also has significant hydrotreating activity of its own. To run Case 2, Reactor 2 was bypassed after running Case 1, so the catalyst charge in Reactor 1 was used for Cases 1 and 2. Cases 4 and 5 focused mainly on hydrotreating to produce a synthetic crude oil of acceptable purity, as determined by the extent of removal of heteroatoms, such as sulfur, nitrogen and oxygen in the feed.

### C. Catalyst Pretreatment

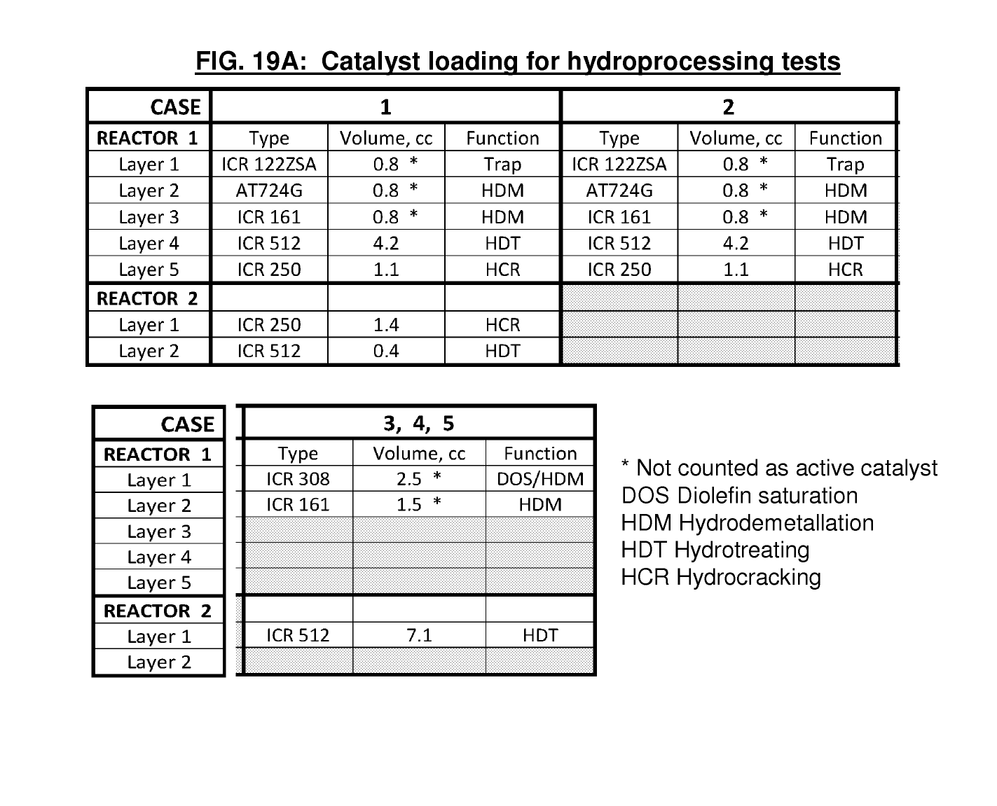

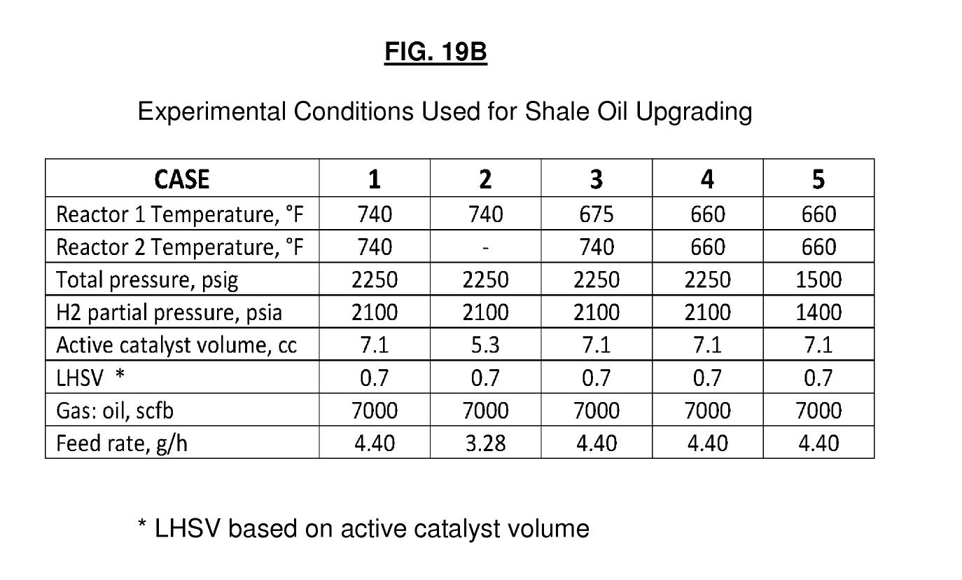

Base metal catalysts, such as the ones typically used for hydroprocessing, need to be converted into the active sulfide form before the start of any actual hydroprocessing. Sulfiding was performed in situ in the liquid phase by contacting the catalysts with a sulfiding feed containing dimethyl disulfide (DMDS) diluted in straight-run diesel. After sulfiding, the catalysts were lined out for three days by feeding straight run diesel at 650° F. and at the target reaction pressure. After the line-out period, the feed was switched to whole pyrolysis liquid product and the temperature was raised to the target reaction temperature at 50° F./hr. Process conditions for all cases are shown in FIG. 19.

### Example 5

### Yields and Characteristics of Hydrotreated Product

Liquid product samples from the stripper or strippers were collected daily for inspections. The gas effluent was also collected daily in a glass bulb for GC analysis. All liquid products were routinely analyzed for API gravity, hydrogen, nitrogen and sulfur content. In addition, the diesel product was tested for cloud point and aromatics concentration by SFC (supercritical fluid chromatography). Selected samples were also tested for oxygen content by NAA (neutron activation analysis). One result of interest was that inclusion of 35% hydrocracking catalyst in the reactor load did not significantly change the yield structure when compared with the load containing 100% hydrotreating catalyst. This may be a result of the unique chemical composition of the pyrolysis-liquid hydrotreating feedstock.

### 1. Yields

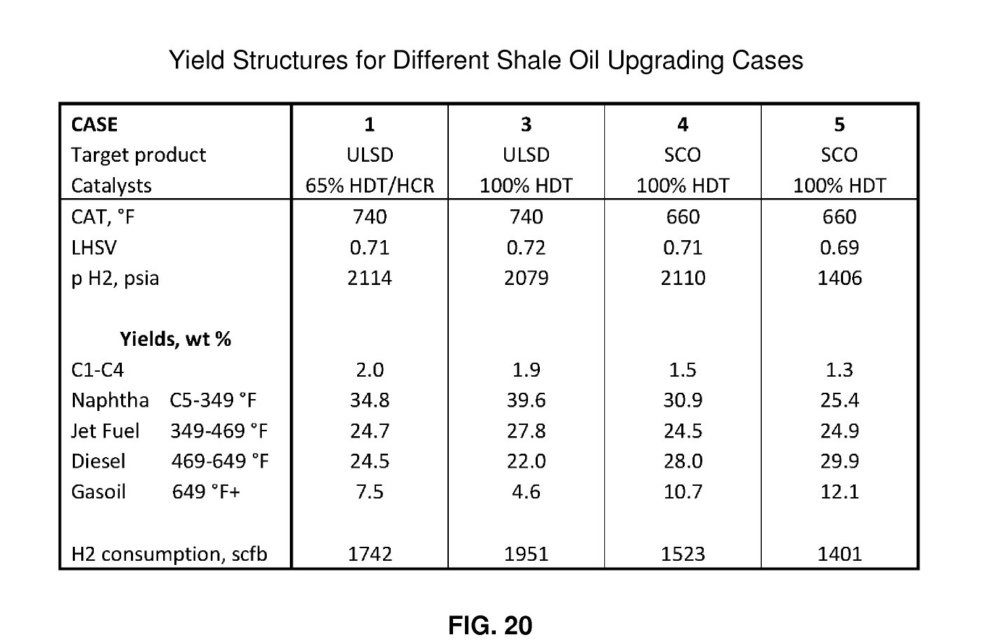

FIG. 20 summarizes the yields of the individual cuts obtained on each of the different upgrading cases, as derived from simdist data of the actual products. In commercial refinery operation water is generally injected downstream of the reactor outlet, to prevent NH₄SH deposition. Because the micro unit lacks this capability, for Case 3 the effluent line had to be operated at higher than normal temperature to prevent the formation of deposits.

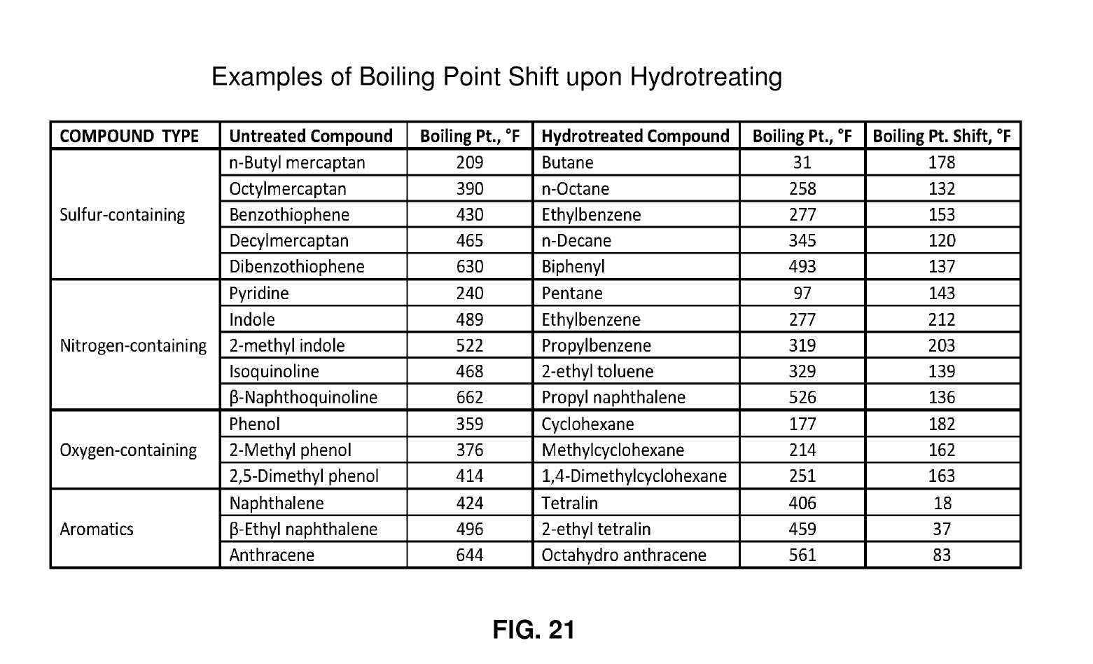

The presence of a hydrocracking catalyst in Case 1 does not result in significantly large differences in yield structure compared with Case 3 (FIG. 20). It was originally expected that the gasoil fraction would be lowest in Case 1, but lighter liquid products with minimum gasoil are actually observed in Case 3. In all cases, there is a shift toward the formation of lighter products. Because formation of light gases (C1-C4) is consistently low, and lowest in the low temperature low pressure case, the general shift in boiling point toward lighter liquids, such as naphtha and jet fuel, is unlikely to be related to cracking, but instead related to the inventor's process. Instead, heteroatom removal and aromatics saturation, which are the main effects of hydrotreating, resulted in hydrocarbon products with significantly lower boiling points than the original untreated compounds. To support this assertion, FIG. 21 shows specific examples of boiling point shifts for compounds of various types upon hydrotreating. In all cases, the hydrotreated hydrocarbon has a significantly lower boiling point than the original compound. Thus, even at the mildest conditions studied here (Case 5) the product yield structure already shows some shift from the original diesel and gas oil-range fractions into naphtha and jet fuel. The highest hydrogen consumption, observed in Case 3, can be correlated with the deepest extent of hydrotreating and with the formation of the lightest liquid product slate.

2. Conversion into Finished Products

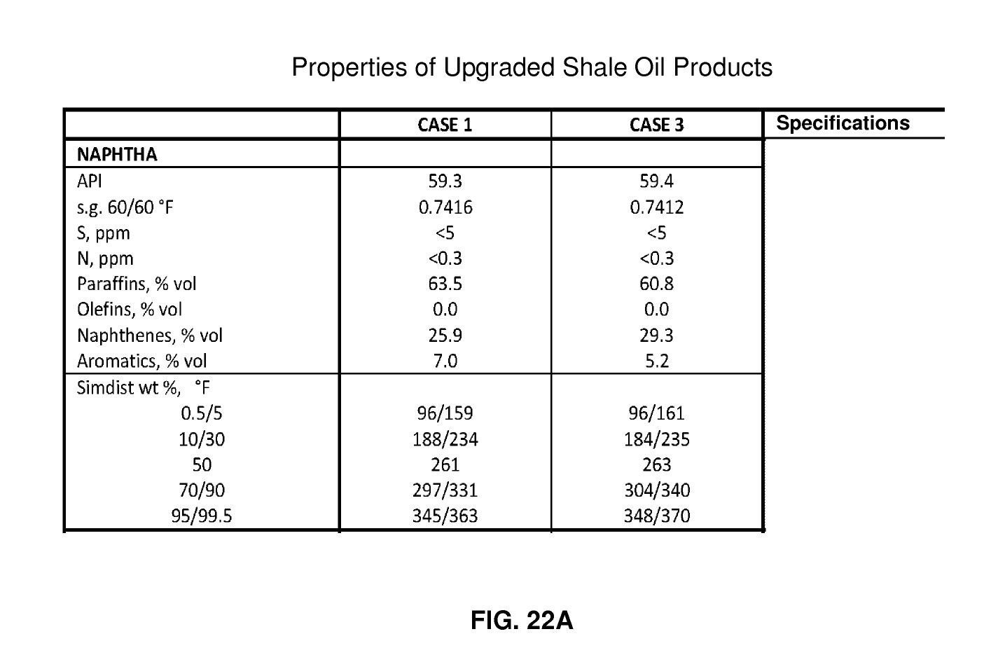

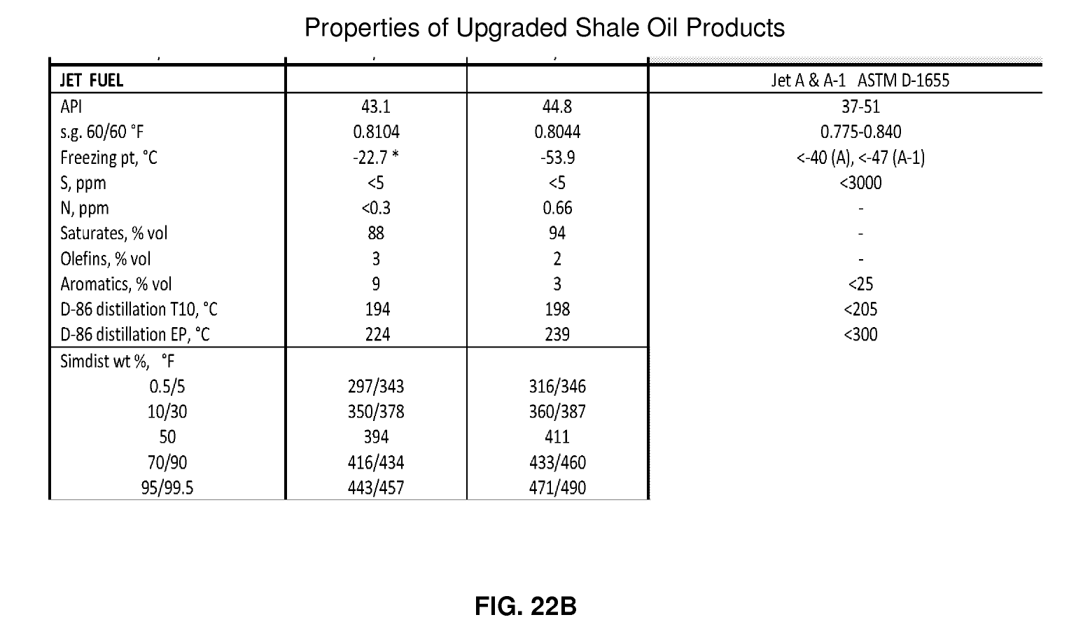

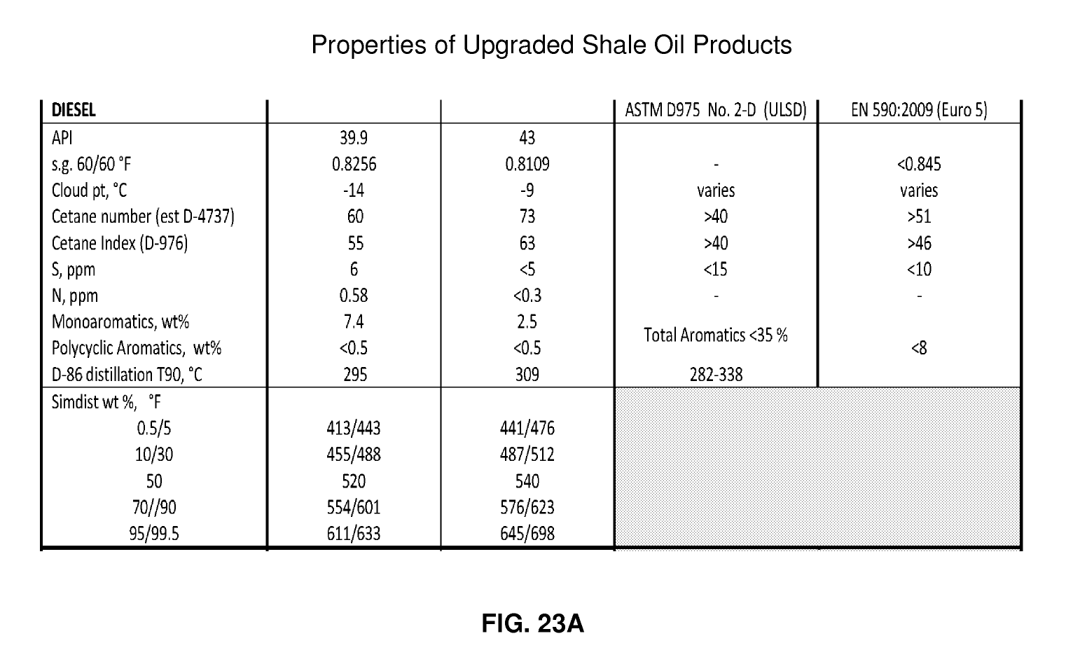

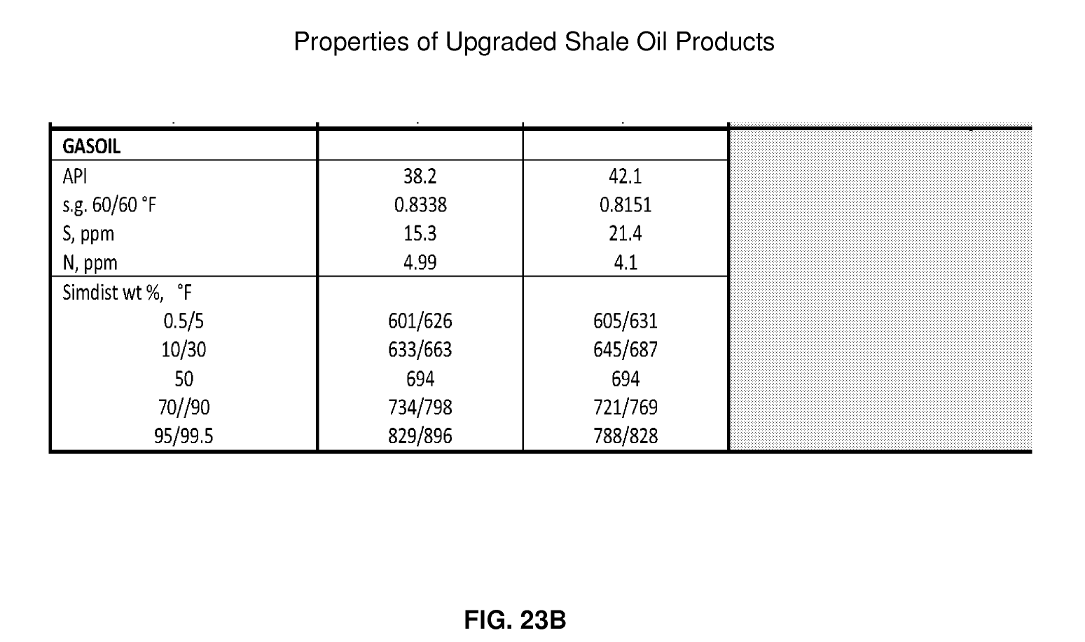

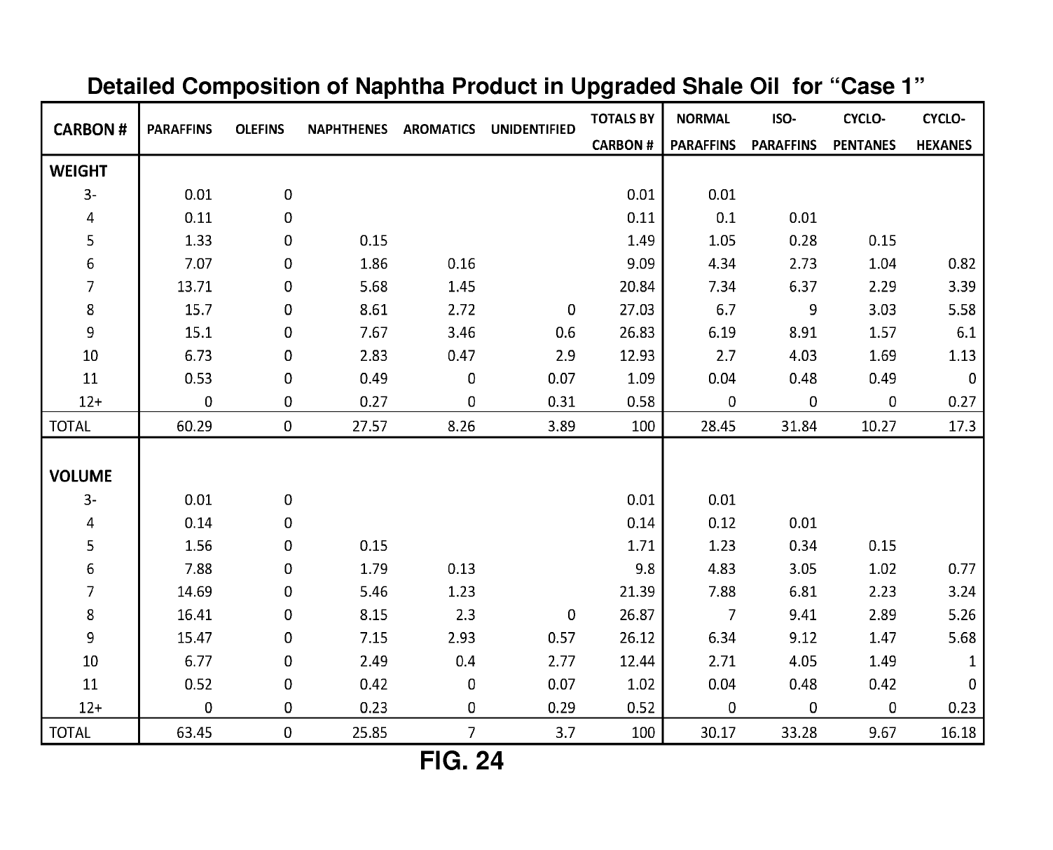

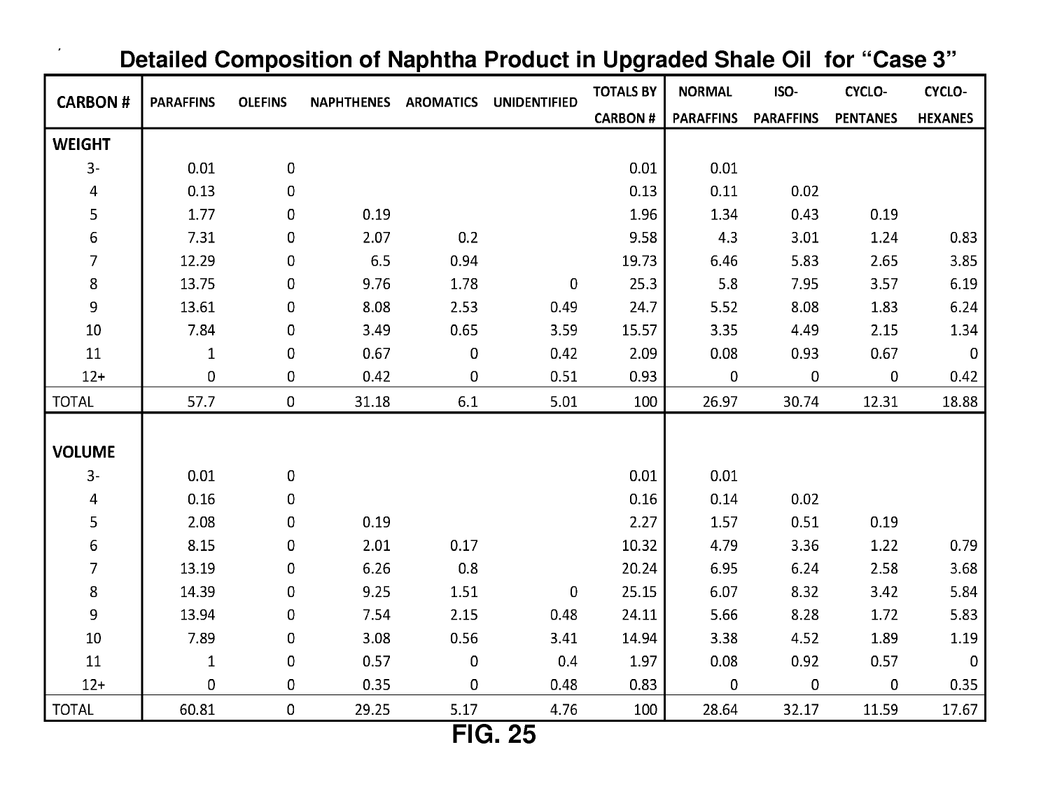

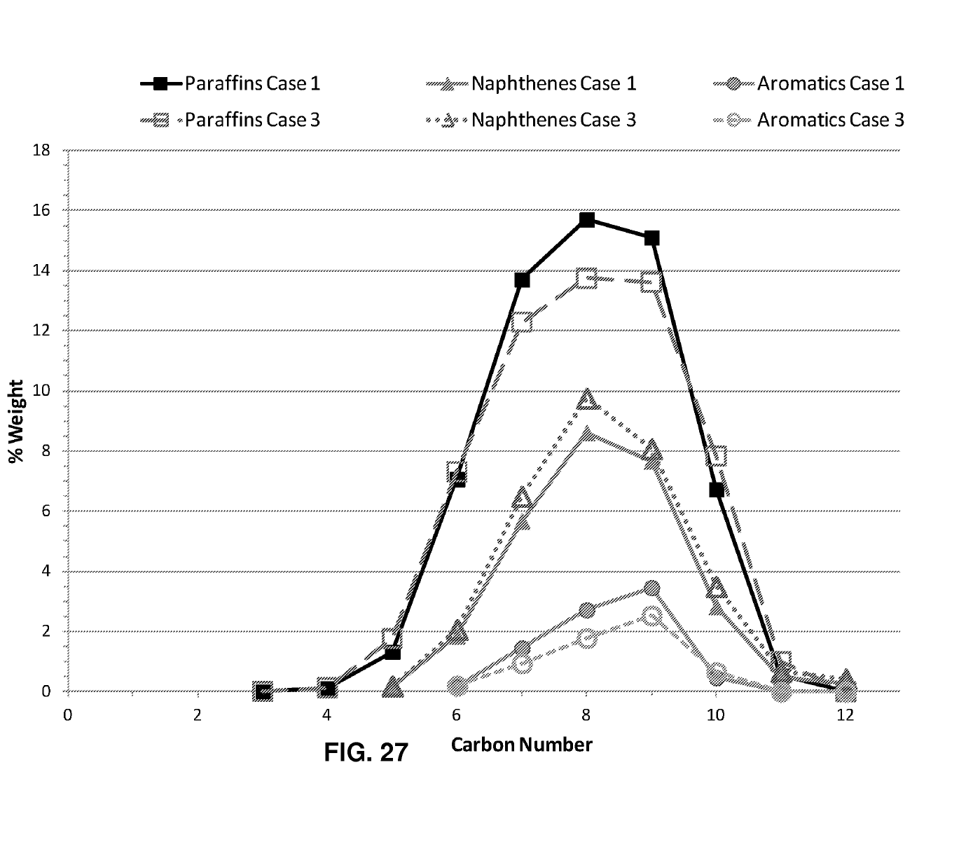

FIG. 22 and FIG. 23 list key properties of the different products obtained on the two tests where generation of finished products, particularly ULSD, was the main objective (Cases 1 and 3). Current specifications for jet fuel and diesel (ULSD and Euro 5) are also shown for comparison. Diesel product from both cases 1 and 3 meets all the ULSD and Euro 5 specs it was tested for. Jet fuel produced meets all the specs both for jet A and jet A-1. Visually, the naphtha, jet fuel and diesel from Cases 1 and 3 are all clear and colorless, which suggests high quality, in agreement with inspections data. The gasoil is a soft off-white solid at room temperature. When melted, it becomes a clear liquid with a very slight yellowish tinge. The high quality of the products, resulting largely from heteroatom removal and aromatics saturation, correlates well with the relatively high hydrogen consumption in all cases, as shown in FIG. 20. FIG. 24 and FIG. 25 show the detailed composition (PONA analysis) of the naphtha product from Cases 1 and 3 respectively. The results are summarized graphically in FIG. 27. Molecules with 8 and 9 carbon atoms are the most abundant in both cases. There are only slight differences in the concentrations of the different types of hydrocarbons between the two cases. In particular, a higher degree of aromatics saturation in Case 3 (100% hydrotreating catalyst) may explain both the lower amount of aromatics and the higher proportion of naphthenes when compared with Case 1, as aromatics are converted into naphthenes upon saturation. Ring-opening of naphthenes over the hydrocracking catalyst layer in Case 1 may explain the higher amount of paraffins in this case.

3. Conversion into SCO

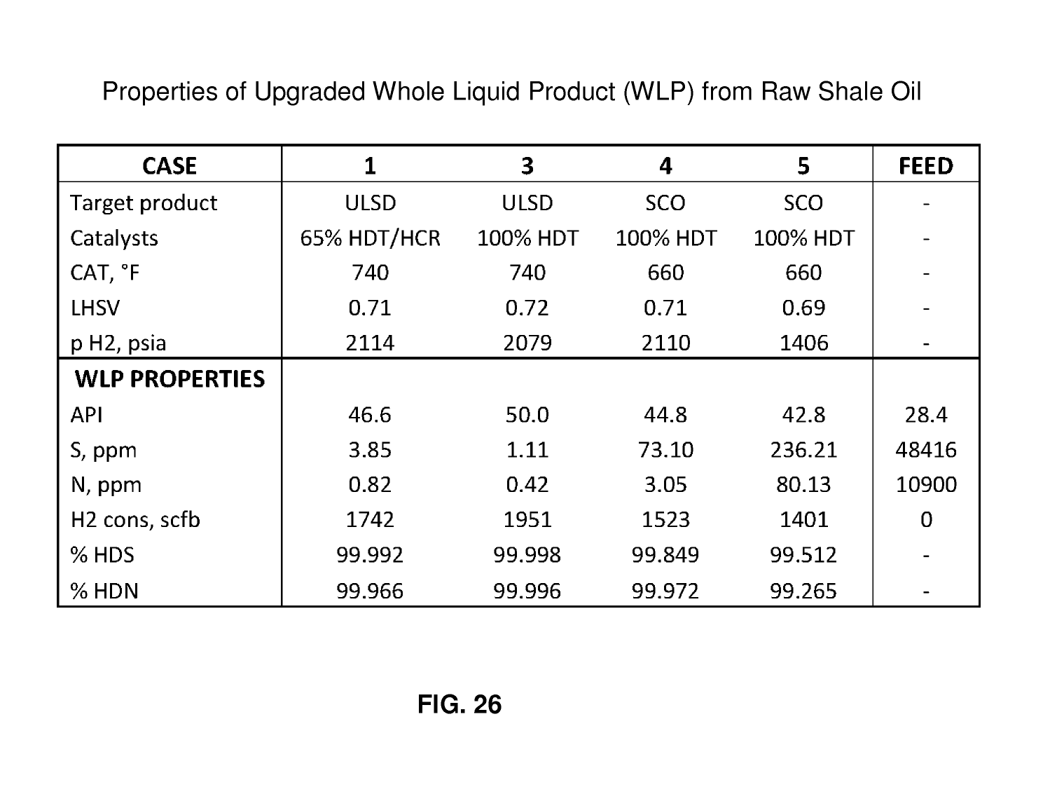

FIG. 26 shows the properties of the upgraded whole liquid product, which we are also calling the hydrocarbon pyrolysis liquid product, for all cases. For Cases 1 and 3, data of the individual products were combined to calculate the properties of the whole liquid product. For Cases 4 and 5 the data correspond to the SCO, the single liquid product collected on these runs. Even for Case 5, run at the mildest conditions, the extent of hydrodesulfurization (HDS) and hydrodenitrification (HDN) exceed 99%. Oxygen removal was also virtually complete, as all the samples analyzed by NAA had oxygen concentrations below the detection limit of 100 ppm. The SCO products from Cases 4 and 5 are clear light yellow liquids at room temperature, with the color somewhat more intense in Case 5. This is not surprising, as aromatics impart color to products and milder conditions result in a lower degree of aromatics saturation. The increased concentration of aromatics in the SCO products correlates well with the increase in density (lower API gravity) and with the lower hydrogen consumption.

Data presented here indicate that even at the mildest conditions studied, removal of heteroatoms upon hydrotreatment is relatively straightforward; during initial planning discussions, production of SCO with 1% wt sulfur had been considered a reasonable objective. The high degree of HDS even at the mildest conditions is easily identifiable in our GC trace using a PFPD to quantify sulfur compounds in Case 5 SCO (not shown here). Afterwards, the only peak on the plot corresponds to elemental sulfur derived from the oxidation in air of residual H₂S in the sample. GC analysis in the PFPD shows that sulfur removal is nearly complete after hydrotreating.

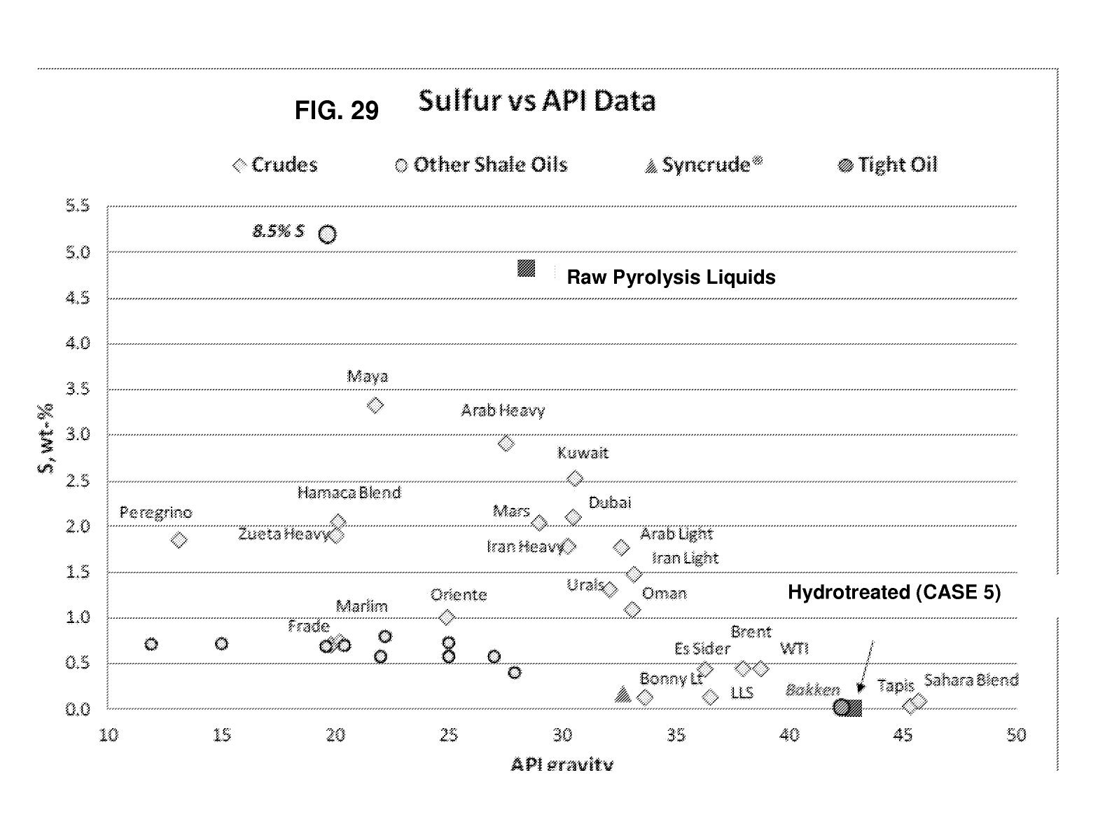

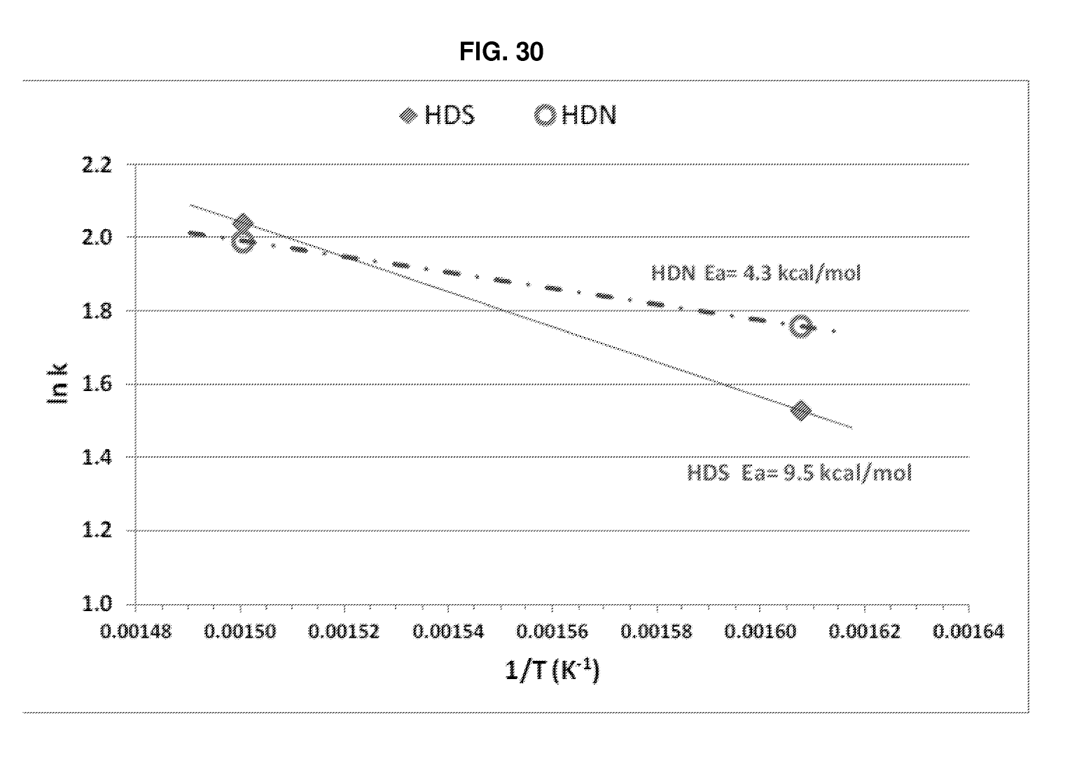

The change in quality from untreated pyrolysis liquid product to SCO can be also plotted as function of sulfur content and API gravity by adding data of Case 5 SCO to FIG. 13. This results in FIG. 29. The SCO is in the range of light sweet crudes, which are generally straightforward to process into final products. By these measures, the SCO is also similar to tight oil from the Bakken formation (North Dakota, USA), which is a mature shale oil, and which is currently processed in refineries into marketable products.

Because the pyrolysis liquid product contains large concentrations of heteroatoms (S, N, O), upon hydrotreatment the product boiling range significantly shifts toward lighter products, such as naphtha and jet fuel. Relatively mild conditions (660° F., 1500 psig total pressure) can be used to produce synthetic crude oil (SCO) of high purity over 100% hydrotreating catalyst while consuming a moderate amount of hydrogen. This SCO is suitable for further upgrading at conventional refineries.

### Example 6

### Self-Sufficient Process in Hydrogen Consumption

Elemental analysis was performed on both the hydrocarbon pyrolysis liquid product and hydrotreated oil. The hydrocarbon pyrolysis liquid product was found to be 11.5% wt and the hydrotreating product 13% wt, so roughly 1.5% wt of H₂ is consumed in the hydrotreating process. The experiments conducted showed that this method produced 700-1000 scf of H₂ per barrel of oil depending on conditions varying either or both temperature and pressure.

Because hydrogen availability is frequently a limiting factor in hydroprocessing operations, the pyrolysis-liquid-derived hydrotreated product properties are plotted as function of the required hydrogen consumption in FIG. 3. This is useful to establish the expected product quality for a given amount of hydrogen consumption. The API gravity for each of those samples is plotted on the right-side y-axis for comparison. The data shows that the hydrotreating process uses up less H₂ than what is produced. The trends observed here for HDS and HDN are similar to those seen in upgrading studies of other shale oils. In this pyrolysis process, a certain amount of hydrogen is produced as the pyrolysis liquid product is being formed. The pyrolysis conditions can be adjusted, within realistic limits, to generate enough hydrogen to upgrade the pyrolysis product to SCO without requiring an external hydrogen supply. For instance, hydrogen production of 800 to 1000 scfb during pyrolysis would enable initial hydroprocessing into SCO having approximately 0.1% wt S and 0.1% wt N, which are values refineries can usually handle when upgrading petroleum feedstocks into final products.

### Example 9

### Hydrotreating Reaction Kinetics Data

The experimental data from these studies can be used to model and optimize conditions for process design and potential future tests. Specifically, data from Cases 3 and 4 can be used to model chemical kinetics of the HDS and HDN reactions as function of temperature. Data from Cases 4 and 5 can be used to explore the pressure dependence of the same reactions.

In their simplest form, hydrodesulfurization and hydrodenitrification reactions can be empirically modeled as first order reactions. In this case, the temperature-dependent rate constant k(T) is related to the conversion of a reactant, such as sulfur or nitrogen, by an equation of the form:

k(T)=LHSV*ln(C_{f}/Cₚ)

Here, C_{f} refers to the reactant's concentration in the feed, Cₚ is the concentration in the product and LHSV is the space velocity.

The rate constant dependence on absolute temperature is given by the Arrhenius equation:

k(T)=A₀exp(−Eₐ/RT)

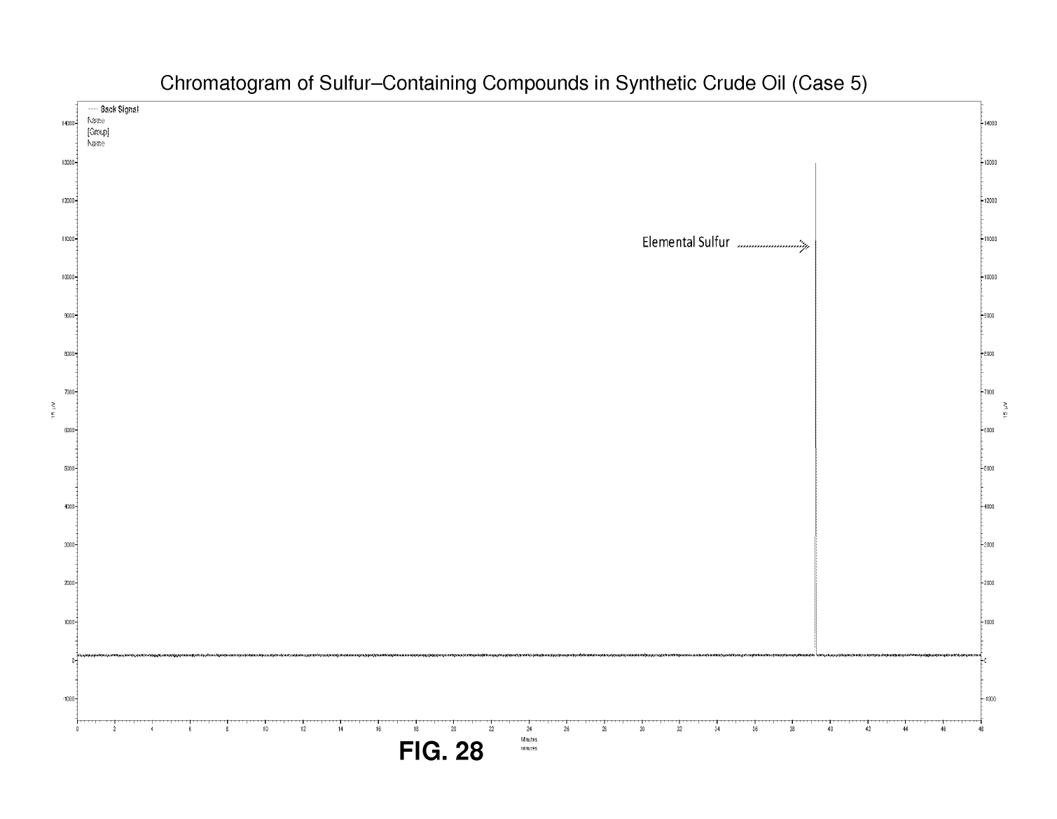

Here, Eₐ is the activation energy of the reaction. The Arrhenius plot (ln k vs 1/T), using data from FIG. 24 to calculate activation energies, is shown in FIG. 28. The resulting activation energies are 9.5 kcal/mol for HDS and 4.3 kcal/mol for HDN. These values are below the commonly observed range of 15-35 kcal/mol for both reactions. In general, lower activation energy implies low responsiveness to temperature changes. The unusually low values measured here suggest that simple first order chemical kinetics do not fully represent the overall reaction rate. Other factors, such as inhibition by high levels of H₂S and NH₃ byproducts, likely affects the availability of active sites; diffusion or chemical equilibrium may also play a role in the overall reaction rates. The dependence of the reaction rate on hydrogen partial pressure can be modeled by the expression:

k₂/k₁=(p_{H2}/p_{H1})^{x}

Here, k is the reaction rate constant (HDS or HDN), p_{H} is the hydrogen partial pressure and subindices 1 and 2 refer to two different conditions. Using data from Cases 4 and 5:
X_{HDS}=0.56
X_{HDN}=1.32

These values are within the common ranges of:
0.5≦x≦1.0 for HDS and
1.0≦x≦2.0 for HDN.

What is claimed is:

1. A oil derived from pyrolysis of type IIs kerogen and/or comprising between 0.05% wt/wt and 5% wt/wt olefins, wherein (i) the oil comprises at least 3% wt/wt sulfur, (ii) a majority of sulfur compounds of the oil are alkylthiophenes; (iii) a ratio between respective concentrations of alkylthiophenes and alkyldibenzothiophenes is at least 10 or at least 15 or at least 20 or at least 30; and (iv) a majority of alkylthiophenes of the oil are thiophene C₄H₄S or C1-C4 alkylhiophenes.

2. The oil of any preceding claim wherein a majority, or a substantial majority, of alkylthiophenes of the oil are thiophene C₄H₄S or C1-C3 alkylhiophenes.

3. The oil of any preceding claim wherein a majority, or a substantial majority, of alkylthiophenes of the oil are C1-C3 alkylhiophenes.

4. The oil of any preceding claim wherein a majority, or a substantial majority, of alkylthiophenes of the oil are thiophene C₄H₄S or C2-C3 alkylhiophenes.

5. The oil of any preceding claim wherein a majority, or a substantial majority, of alkylthiophenes of the oil are C2-C3 alkylhiophenes.

6. The oil of any preceding claim wherein a majority, or a substantial majority, of alkylthiophenes of the oil are C1-C4 alkylhiophenes.

7. The oil of claim 1 wherein a majority, or a substantial majority, of alkylthiophenes of the oil are C2-C3 alkylhiophenes.

8. The oil of any preceding wherein a majority, of a substantial majority, of alkylthiophenes of the oil are C1-C3 alkylhiophenes.

9. An oil derived from pyrolysis of type IIs kerogen and/or comprising between 0.05% wt/wt and 5% wt/wt olefins, wherein (i) the oil comprises at least 3% wt/wt sulfur, (ii) a majority of sulfur compounds of the oil are alkylthiophenes; (iii) a ratio between respective concentrations of alkylthiophenes and alkyldibenzothiophenes is at least 10 or at least 15 or at least 20; and (iv) a majority of alkylthiophenes of the oil are thiophene C₄H₄S or alklyated thiophenes that are alkylated only by methyl group(s).

10. An oil derived from pyrolysis of kerogen and/or comprising between 0.05% wt/wt and 5% wt/wt olefins and at least 0.1% or at least 0.2% or at least 0.5% or at least 1% wt/wt sulfur, wherein (i) a majority of sulfur compounds of the oil are alkylthiophenes or alkylbenzothiophenes or alkyldibenzothiophenes, and (ii) a majority of alkylthiophenes of the oil are thiophene C₄H₄S or alkylated thiophenes that are alkylated only by methyl group(s); and/or a majority of alkylbenzothiophenes of the oil are benzothiophene C₈H₆S or alkylated benzothiophenes that are alkylated only by methyl group(s).

11. An oil derived from pyrolysis of kerogen and/or comprising between 0.05% wt/wt and 5% wt/wt olefins wherein (i) alkylthiophenes-thereof comprise primarily thiophene C₄H₄S or Ci-Cj alkylthiophenes; and/or (ii) alkylpyridines thereof comprise primarily pyridine C₅H₅N or Ck-Cl alkylpyridines and/or (iii) alkylpyrroles-thereof comprise primarily pyrrole C₄H₅N or Cm-Cn alkylpyrroles, wherein i, j, k, l, m and n are all positive integers, j>i, k>l, n>m, and wherein j, l, and n are each equal to at most 5 or at most 4 or at most 3.

12. The oil of any preceding claim wherein alkylthiophenes-thereof comprise primarily thiophene or Ci-Cj alkylthiophenes.

13. The oil of any preceding claim wherein a substantial majority of, or substantially all of the alkylthiophenes-thereof are thiophene or Ci-Cj alkylthiophenes.

14. The oil of any preceding claim wherein alkylthiophenes-thereof comprise primarily Ci-Cj alkylthiophenes.

15. The oil of any preceding claim wherein a substantial majority of, or substantially all of the alkylthiophenes-thereof are Ci-Cj alkylthiophenes.

16. The oil of any preceding claim wherein a value of i is equal to 2.

17. The oil of any preceding claim wherein alkylpyridines-thereof comprise primarily pyridine or Ck-l alkylpyridines.

18. The oil of any preceding claim wherein a substantial majority of, or substantially all of the alkylpyridines-thereof are pyridine or Ck-l alkylpyridines.

19. The oil of any preceding claim wherein alkylpyridines-thereof comprise primarily Ck-l alkylpyridines.

20. The oil of any preceding claim wherein a substantial majority of, or substantially all of the alkylpyridines-thereof are Ck-l alkylpyridines.

21. The oil of any preceding claim wherein a value of k is equal to 2.

22. The oil of any preceding claim wherein alkylpyrroles-thereof comprise primarily pyrrole or Cm-n alkylpyrroles.

23. The oil of any preceding claim wherein a substantial majority of, or substantially all of the alkylpyrroles-thereof are pyrrole or Cm-n alkylpyrroles.

24. The oil of any preceding claim wherein alkylpyrroles-thereof comprise primarily Cm-n alkylpyrroles.

25. The oil of any preceding claim wherein a substantial majority of, or substantially all of the alkylpyrroles-thereof are Cm-n alkylpyrroles.

26. The oil of any preceding claim wherein a value of m is equal to 2.

27. An oil comprising between 0.05% wt/wt and 5% wt/wt olefins and/or derived from pyrolysis of kerogen wherein (i) alkylthiophenes-thereof comprise primarily thiophene C₄H₄S or C1-C3 thiophenes; and/or (ii) alkyl-pyridines thereof comprise primarily pyridine C₅H₅N or C1-C3 pyridines and/or (iii) alkyl-pyrroles thereof comprise primarily pyrrole C₄H₅N or C1-C3 pyrroles.

28. An oil derived from pyrolysis of kerogen wherein alkylthiophenes-thereof comprise primarily C2-C3 thiophenes and/or alkyl-pyridines thereof comprise primarily C2-C3 pyridines and/or alkyl-pyrroles thereof comprise primarily C2-C3 pyrroles.

29. An oil derived from pyrolysis of kerogen and/or comprising between 0.05% wt/wt and 5% wt/wt olefins wherein (i) alkylthiophenes-thereof comprise primarily thiophene C₄H₄S or methyl-thiophene or di-methyl-thiophene or tri-methyl-thiophene or tetra-methyl-thiophene; and/or (ii) alkyl-pyridines thereof comprise primarily pyridine C₅H₅N or methyl-pyridine or di-methyl-pyridine or tri-methyl-pyridine or tetra-methyl-pyridine and/or (iii) alkyl-pyrroles thereof comprise primarily pyrrole C₄H₅N or methyl-pyrrole or di-methyl-pyrrole or tri-methyl-pyrrole or tetra-methyl-pyrrole.

30. The oil of any preceding claim wherein (i) alkylthiophenes-thereof comprise primarily thiophene C₄H₄S or methyl-thiophene or di-methyl-thiophene or tri-methyl-thiophene or tetra-methyl-thiophene or (ii) a substantial majority of, or substantially all of the alkylthiophenes-thereof are thiophene C₄H₄S or methyl-thiophene or di-methyl-thiophene or tri-methyl-thiophene or tetra-methyl-thiophene.

31. The oil of any preceding claim wherein (i) alkylthiophenes-thereof comprise primarily thiophene C₄H₄S or methyl-thiophene or di-methyl-thiophene or tri-methyl-thiophene or (ii) a substantial majority of, or substantially all of the alkylthiophenes-thereof are thiophene C₄H₄S or methyl-thiophene or di-methyl-thiophene or tri-methyl-thiophene.

32. The oil of any preceding claim wherein (i) alkylthiophenes-thereof comprise primarily methyl-thiophene or di-methyl-thiophene or tri-methyl-thiophene or (ii) a substantial majority of, or substantially all of the alkylthiophenes-thereof are methyl-thiophene or di-methyl-thiophene or tri-methyl-thiophene.

33. The oil of any preceding claim wherein (i) alkylthiophenes-thereof comprise primarily di-methyl-thiophene or tri-methyl-thiophene or (ii) a substantial majority of, or substantially all of the alkylthiophenes-thereof are di-methyl-thiophene or tri-methyl-thiophene.

34. The oil of any preceding claim wherein (i) alkylthiophenes-thereof comprise primarily methyl-thiophene or di-methyl-thiophene or tri-methyl-thiophene or tetra-methyl-thiophene or (ii) a substantial majority of, or substantially all of the alkylthiophenes-thereof are methyl-thiophene or di-methyl-thiophene or tri-methyl-thiophene or tetra-methyl-thiophene.

35. The oil of any preceding claim wherein (i) alkylthiophenes-thereof comprise primarily di-methyl-thiophene or tri-methyl-thiophene or tetra-methyl-thiophene or (ii) a substantial majority of, or substantially all of the alkylthiophenes-thereof are di-methyl-thiophene or tri-methyl-thiophene or tetra-methyl-thiophene.

36. The oil of any preceding claim wherein (i) alkylpyrroles-thereof comprise primarily pyrrole C₅H₅N or methyl-pyrrole or di-methyl-pyrrole or tri-methyl-pyrrole or tetra-methyl-pyrrole or (ii) a substantial majority of, or substantially all of the alkylpyrroles-thereof are pyrrole C₄H₄S or methyl-pyrrole or di-methyl-pyrrole or tri-methyl-pyrrole or tetra-methyl-pyrrole.

37. The oil of any preceding claim wherein (i) alkylpyrroles-thereof comprise primarily pyrrole C₅H₅N or methyl-pyrrole or di-methyl-pyrrole or tri-methyl-pyrrole or (ii) a substantial majority of, or substantially all of the alkylpyrroles-thereof are pyrrole C₄H₄S or methyl-pyrrole or di-methyl-pyrrole or tri-methyl-pyrrole.

38. The oil of any preceding claim wherein (i) alkylpyrroles-thereof comprise primarily methyl-pyrrole or di-methyl-pyrrole or tri-methyl-pyrrole or (ii) a substantial majority of, or substantially all of the alkylpyrroles-thereof are methyl-pyrrole or di-methyl-pyrrole or tri-methyl-pyrrole.

39. The oil of any preceding claim wherein (i) alkylpyrroles-thereof comprise primarily di-methyl-pyrrole or tri-methyl-pyrrole or (ii) a substantial majority of, or substantially all of the alkylpyrroles-thereof are di-methyl-pyrrole or tri-methyl-pyrrole.

40. The oil of any preceding claim wherein (i) alkylpyrroles-thereof comprise primarily methyl-pyrrole or di-methyl-pyrrole or tri-methyl-pyrrole or tetra-methyl-pyrrole or (ii) a substantial majority of, or substantially all of the alkylpyrroles-thereof are methyl-pyrrole or di-methyl-pyrrole or tri-methyl-pyrrole or tetra-methyl-pyrrole.

41. The oil of any preceding claim wherein (i) alkylpyrroles-thereof comprise primarily di-methyl-pyrrole or tri-methyl-pyrrole or tetra-methyl-pyrrole or (ii) a substantial majority of, or substantially all of the alkylpyrroles-thereof are di-methyl-pyrrole or tri-methyl-pyrrole or tetra-methyl-pyrrole.

42. The oil of any preceding claim wherein (i) alkylpyridines-thereof comprise primarily pyridine C₅H₅N or methyl-pyridine or di-methyl-pyridine or tri-methyl-pyridine or tetra-methyl-pyridine or (ii) a substantial majority of, or substantially all of the alkylpyridines-thereof are pyridine C₄H₄S or methyl-pyridine or di-methyl-pyridine or tri-methyl-pyridine or tetra-methyl-pyridine.

43. The oil of any preceding claim wherein (i) alkylpyridines-thereof comprise primarily pyridine C₅H₅N or methyl-pyridine or di-methyl-pyridine or tri-methyl-pyridine or (ii) a substantial majority of, or substantially all of the alkylpyridines-thereof are pyridine C₄H₄S or methyl-pyridine or di-methyl-pyridine or tri-methyl-pyridine.

44. The oil of any preceding claim wherein (i) alkylpyridines-thereof comprise primarily methyl-pyridine or di-methyl-pyridine or tri-methyl-pyridine or (ii) a substantial majority of, or substantially all of the alkylpyridines-thereof are methyl-pyridine or di-methyl-pyridine or tri-methyl-pyridine.

45. The oil of any preceding claim wherein (i) alkylpyridines-thereof comprise primarily di-methyl-pyridine or tri-methyl-pyridine or (ii) a substantial majority of, or substantially all of the alkylpyridines-thereof are di-methyl-pyridine or tri-methyl-pyridine.

46. The oil of any preceding claim wherein (i) alkylpyridines-thereof comprise primarily methyl-pyridine or di-methyl-pyridine or tri-methyl-pyridine or tetra-methyl-pyridine or (ii) a substantial majority of, or substantially all of the alkylpyridines-thereof are methyl-pyridine or di-methyl-pyridine or tri-methyl-pyridine or tetra-methyl-pyridine.

47. The oil of any preceding claim wherein (i) alkylpyridines-thereof comprise primarily di-methyl-pyridine or tri-methyl-pyridine or tetra-methyl-pyridine or (ii) a substantial majority of, or substantially all of the alkylpyridines-thereof are di-methyl-pyridine or tri-methyl-pyridine or tetra-methyl-pyridine.

48. The oil of any preceding claim wherein at 10% or at least 20% or at least 30% or a majority of alkanes thereof are CN-C20 alkanes wherein N is an integer selected from the group consisting of 6, 7, 8, 9, 10 and 11.

49. The oil of any preceding claim wherein the oil is derived from pyrolysis of kerogen.

50. The oil of any preceding claim comprising between 0.05% wt/wt and 5% wt/wt olefins.

51. The oil of any preceding claim comprising at least 0.1% wt/wt or at least 0.2% wt/wt or at least 0.3% wt/wt olefins and/or at most 4% wt/wt or at most 3% wt/wt olefins.

52. The oil of any preceding claim wherein the oil is alkylthiophene-rich and/or alkylpyridine-rich and/or alkylpyrrole-rich.

53. The oil of any preceding claim wherein alkylbenzothiophenes-thereof comprise primarily benzothiophenes C₄H₄S or alkylated benzothiophenes that are alkylated only by methyl group(s).

54. The oil of any preceding claim wherein a ratio between respective concentrations of alkylbenzothiophenes and alkylthiophenes is at least 0.1 or at least 0.2.

55. The oil of any preceding claim wherein a substantial majority of, or substantially all of the alkylthiophenes-thereof are thiophene C₄H₄S or alkylated thiophenes that are alkylated only by methyl group(s).

56. The oil of any preceding claim wherein a majority of, or a substantial majority of, or substantially all of the alkylthiophenes-thereof are alkylated thiophenes that are alkylated only by methyl group(s).

57. The oil of any preceding claim, comprising at least 0.1% wt/wt or at least 0.2% wt/wt or at least 0.5% wt/wt or at least 1% wt/wt nitrogen.

58. The oil of any preceding claim, comprising at least 0.2% wt/wt or at least 0.5% wt/wt or at least 1% wt/wt or at least 2% wt/wt or at least 3% wt/wt sulfur.

59. The oil of any preceding claim wherein a majority of nitrogen compounds of the oil are alkylthiophenes or alkylpyrroles.

60. The oil of any preceding claim wherein alkylpyridines thereof comprise primarily pyridine C₅H₅N or alkylated pyridines that are alkylated only by methyl group(s).

61. The oil of any preceding claim wherein alkylpyrroles thereof comprise primarily pyrrole C₄H₅N or alkylated pyrroles that are alkylated only by methyl group(s).

62. The oil of any preceding claim wherein a ratio between respective concentrations of alkylpyridines and alkylacridines is at least 10 or at least 15 or at least 20.

63. The oil of any preceding claim wherein a ratio between respective concentrations of alkylpyrroles and alkylcarbazoles is at least 10 or at least 15 or at least 20.

64. The oil of any preceding claim having an API gravity of at least 20 or at least 25 or at least 30 or at least 35 or at least 40 and/or a pour point of at most 0 degrees Celsius.

65. The oil of any preceding claim having a 40° Celsius-viscosity of at most 5 cP or at most 3 cP or at most 2 cP or at most 1.5 cP or at most 1 cP.

66. The oil of any preceding claim wherein a concentration of nickel therein is at most 2 ppm or at most 1 ppm.

67. The oil of any preceding claim wherein a concentration of vanadium therein is at most 2 ppm or at most 1 ppm.

68. The oil of any preceding claim wherein a concentration of arsenic therein is at most 2 ppm or at most 1 ppm.

69. The oil of any preceding claim wherein a ratio between respective concentrations of alkylthiophenes and alkyldibenzothiophenes is at least 10 or at least 15 or at least 20 or at least 30.

70. The oil of preceding claim wherein a ratio between:
i. a concentration of alkylthiophenes within the oil;
ii. a concentration of alkyldibenzothiophenes within the oil
is at least about 15 or at least about 20 or at least about 25 or least about 30 or at least about 50.

71. The oil of any preceding claim wherein a ratio between:
i. a concentration of alkyl pyrroles within the oil;
ii. a concentration of alkyl carbazoles within the oil
is at least about 15 or at least about 20 or at least about 25 or least about 30 or at least about 50.

72. The oil of any preceding claim wherein a ratio between:
i. a concentration of alkyl pyridines within the oil;
ii. a concentration of alkyl acridines within the oil
is at least about 15 or at least about 20 or at least about 25 or least about 30 or at least about 50.

73. The oil of any preceding claim wherein a ratio between:
i. a concentration of alkylated thiophenes within the oil;
ii. a concentration of thiophenes C₄H₄S within the oil
is at least about 3 or at least about 5 or at least about 10 or least about 20 or at least about 30 or at least about 50 or at least about 75 or at least about 100 or at least about 150 or at least about 200.

74. The oil of any preceding claim wherein a ratio between:
i. a concentration of alkylated pyrroles within the oil;
ii. a concentration of pyrroles C₄H₅N within the oil
is at least about 3 or at least about 5 or at least about 10 or least about 20 or at least about 30 or at least about 50 or at least about 75 or at least about 100 or at least about 150 or at least about 200.

75. The oil of any preceding claim wherein a ratio between:
i. a concentration of alkylated pyridines within the oil;
ii. a concentration of pyridines C₅H₅N within the oil
is at least about 3 or at least about 5 or at least about 10 or least about 20 or at least about 30 or at least about 50 or at least about 75 or at least about 100 or at least about 150 or at least about 200.

76. The oil of any preceding claim wherein a ratio between:
i. a concentration of C2-C3 thiophenes within the oil;
ii. a concentration of C1 thiophenes within the oil;
is at least about at least about 10 or at least about 15 or at least about 20 or at least about 25 or at least about 30 or at least about 50.

77. The oil of any preceding claim wherein a ratio between:
i. a concentration of C2-C3 pyrroles within the oil;
ii. a concentration of C1 pyrroles within the oil;
is at least about at least about 10 or at least about 15 or at least about 20 or at least about 25 or at least about 30 or at least about 50.

78. The oil of any preceding claim wherein a ratio between:
i. a concentration of C2-C3 pyridines within the oil;
ii. a concentration of C1 pyridines within the oil;
is at least about at least about 10 or at least about 15 or at least about 20 or at least about 25 or at least about 30 or at least about 50.

79. The oil of any preceding claim wherein a ratio between:
i. a concentration of C1-thiophenes within the oil;
ii. a concentration of C1-dibenzothiophenes within the oil;
is at least about 15 or at least about 20 or at least about 25 or least about 30 or at least about 50.

80. The oil of any preceding claim wherein a ratio between:
i. a concentration of C1-pyrroles within the oil;
ii. a concentration of C1-carbazoles within the oil;
is at least about 15 or at least about 20 or at least about 25 or least about 30 or at least about 50.

81. The oil of any preceding claim wherein a ratio between:
i. a concentration of C1-pyridines within the oil;
ii. a concentration of C1-acridines within the oil;
is at least about 15 or at least about 20 or at least about 25 or least about 30 or at least about 50.

82. The oil of any preceding claim wherein a ratio between:
i. a concentration of C2-thiophenes within the oil;
ii. a concentration of C2-dibenzothiophenes within the oil;
is at least about 5 or at least about 10 or at least about 15 or at least about 20 or at least about 25 or least about 30 or at least about 50.

83. The oil of any preceding claim wherein a ratio between:
i. a concentration of C2-pyrroles within the oil;
ii. a concentration of C2-carbazoles within the oil;
is at least about 5 or at least about 10 or at least about 15 or at least about 20 or at least about 25 or least about 30 or at least about 50.

84. The oil of any preceding claim wherein a ratio between:
i. a concentration of C2-pyridines within the oil;
ii. a concentration of C2-acridines within the oil;
is at least about 5 or at least about 10 or at least about 15 or at least about 20 or at least about 25 or least about 30 or at least about 50.

85. The oil of any preceding claim wherein a ratio between:
i. a concentration of C3-thiophenes within the oil;
ii. a concentration of C3-dibenzothiophenes within the oil;
is at least about 10 or at least about 15 or at least about 20 or at least about 25 or least about 30 or at least about 50 or at least about 75 or at least about 100.

86. The oil of any preceding claim wherein a ratio between:
i. a concentration of C3-pyrroles within the oil;
ii. a concentration of C3-carbazoles within the oil;
is at least about 10 or at least about 15 or at least about 20 or at least about 25 or least about 30 or at least about 50 or at least about 75 or at least about 100.

87. The oil of any preceding claim wherein a ratio between:
i. a concentration of C3-pyridines within the oil;
ii. a concentration of C3-acridines within the oil;
is at least about 10 or at least about 15 or at least about 20 or at least about 25 or least about 30 or at least about 50 or at least about 75 or at least about 100.

88. The oil of any preceding claim wherein a ratio between:
i. a concentration of C3-thiophenes within the oil;
ii. a concentration of C3-benzothiophenes within the oil;
is at least about 2 or at least about 3 or at least about 4 or at least about 5 or least about 6 or at least about 8 or at least about 10 or at least about 15 or at least about 20 or at least about 50 or at least about 100.

89. The oil of any preceding claim wherein a ratio between:
i. a concentration of C3-pyrroles within the oil;
ii. a concentration of C3-indoles within the oil;
is at least about 2 or at least about 3 or at least about 4 or at least about 5 or least about 6 or at least about 8 or at least about 10 or at least about 15 or at least about 20 or at least about 50 or at least about 100.

90. The oil of any preceding claim wherein a ratio between:
i. a concentration of C3-pyridines within the oil;
ii. a concentration of C3-quinolines within the oil;
is at least about 2 or at least about 3 or at least about 4 or at least about 5 or least about 6 or at least about 8 or at least about 10 or at least about 15 or at least about 20 or at least about 50 or at least about 100.

91. The oil of any preceding claim wherein a ratio between:
i. a concentration of C3-pyridines within the oil;
ii. a concentration of C3-isoquinolines within the oil;
is at least about 2 or at least about 3 or at least about 4 or at least about 5 or least about 6 or at least about 8 or at least about 10 or at least about 15 or at least about 20 or at least about 50 or at least about 100.

92. The oil of any preceding claim wherein a ratio between:
i. a concentration of C3-pyridines within the oil;
ii. a sum of concentrations of C3-isoquinolines and C3-quinolines within the oil;
is at least about 2 or at least about 3 or at least about 4 or at least about 5 or least about 6 or at least about 8 or at least about 10 or at least about 15 or at least about 20 or at least about 50 or at least about 100.

93. The oil of any preceding claim wherein a ratio between:
i. a concentration of alkylated thiophenes;
ii. a concentration of benzothiophenes C₈H₆S
is at least about 3 or at least about 5 or at least about 10 or least about 20 or at least about 30 or at least about 50 or at least about 50 or at least about 100.

94. The oil of any preceding claim wherein a ratio between:
i. a concentration of alkylated pyrroles;
ii. a concentration of indoles C₈H₇N
is at least about 3 or at least about 5 or at least about 10 or least about 20 or at least about 30 or at least about 50.

95. The oil of any preceding claim wherein a ratio between:
i. a concentration of alkylated pyridines;
ii. a concentration of quinolines C₉H₇N
is at least about 3 or at least about 5 or at least about 10 or least about 20 or at least about 30 or at least about 50.

96. The oil of any preceding claim wherein a ratio between:
i. a concentration of alkylated pyridines;
ii. a concentration of isoquinolines C₉H₇N
is at least about 3 or at least about 5 or at least about 10 or least about 20 or at least about 30 or at least about 50.

97. The oil of any preceding claim wherein a ratio between:
i. a concentration of alkylated pyridines;
ii. a concentration of the mix of quinolines C₉H₇N and isoquinolines C₉H₇N
is at least about 3 or at least about 5 or at least about 10 or least about 20 or at least about 30 or at least about 50.

98. The oil of any preceding claim wherein a ratio between:
i. a concentration of alkylated thiophenes;
ii. a concentration of alkylated benzothiophenes
is at least about 3 or at least about 5 or at least about 10 or least about 20 or at least about 30 or at least about 50.

99. The oil of any preceding claim wherein a ratio between:
i. a concentration of alkylated pyrroles;
ii. a concentration of alkylated indoles
is at least about 3 or at least about 5 or at least about 10 or least about 20 or at least about 30 or at least about 50.

100. The oil of any preceding claim wherein a ratio between:
i. a concentration of alkylated pyridines;
ii. a concentration of alkylated quinolines
is at least about 3 or at least about 5 or at least about 10 or least about 20 or at least about 30 or at least about 50.]

101. The oil of any preceding claim wherein a ratio between:
i. a concentration of alkylated pyridines;
ii. a concentration of alkylated isoquinolines
is at least about 3 or at least about 5 or at least about 10 or least about 20 or at least about 30 or at least about 50.

102. The oil of any preceding claim wherein a ratio between:
i. a concentration of alkylated pyridines;
ii. a sum of concentrations of alkylated quinolines and alkylated isoquinolines
is at least about 3 or at least about 5 or at least about 10 or least about 20 or at least about 30 or at least about 50.

103. The oil of any preceding claim wherein a ratio between:
i. a concentration of alkylated thiophenes;
ii. a concentration of dibenzothiophenes C₁₂H₈S
is at least about 3 or at least about 5 or at least about 10 or least about 20 or at least about 30 or at least about 50 or at least about 100.

104. The oil of any preceding claim wherein a ratio between:
i. a concentration of alkylated pyrroles;
ii. a concentration of carbazoles
is at least about 3 or at least about 5 or at least about 10 or least about 20 or at least about 30 or at least about 50 or at least about 100.

105. The oil of any preceding claim wherein a ratio between:
i. a concentration of alkylated pyridines;
ii. a concentration of acridines
is at least about 3 or at least about 5 or at least about 10 or least about 20 or at least about 30 or at least about 50 or at least about 100.

106. The oil of any preceding claim wherein a ratio between:
i. a concentration of alkylated thiophenes;
ii. a concentration of alkylated dibenzothiophenes
is at least about 3 or at least about 5 or at least about 10 or least about 20 or at least about 30 or at least about 50 or at least about 100 or at least about 200.

107. The oil of any preceding claim wherein a ratio between:
i. a concentration of alkylated pyrroles;
ii. a concentration of alkylated carbazoles
is at least about 3 or at least about 5 or at least about 10 or least about 20 or at least about 30 or at least about 50 or at least about 100 or at least about 200.

108. The oil of any preceding claim wherein a ratio between:
i. a concentration of alkylated pyridines;
ii. a concentration of alkylated acridines
is at least about 3 or at least about 5 or at least about 10 or least about 20 or at least about 30 or at least about 50 or at least about 100 or at least about 200.

109. A method of refining comprising hydrotreating the oil of any previous claim into a sweetened oil have a reduced sulfur content.

110. A sweetened oil derived by the method of claim 109.

111. A transportation fuel derived from the sweetened oil of claim 110.

112. A hydrotreated derivative of any oil of any preceding claim.

113. The derivate of claim 122, wherein the derivative is a transportation fuel.

114. Use of the oil of any preceding claims as an enhanced oil recovery (EOR) fluid.

115. A hydrocarbon production method that is self-sufficient with respect to hydrogen gas, the method comprising:
pyrolyzing type IIs kerogen having an average sulfur content of at least 8% wt/wt and an average nitrogen content of at least 1.5% wt/wt so as to generate pyrolysis gases and pyrolysis hydrocarbon liquids;
hydrotreating the pyrolysis hydrocarbon liquids, within a hydrotreater, under only low-severity conditions of at most about 350 degrees Celsius and a maximum pressure of at most 120 atmospheres to produce a sweetened synthetic crude oil, wherein the hydrotreating is sustained only by the hydrogen gas component of the pyrolysis gases and the sweetened synthetic crude oil has a sulfur concentration of at most 1% wt/wt, a nitrogen concentration of at most 0.2% wt/wt and an API gravity of at least 30.

116. The method of any previous claim wherein at most only about 220 Nm³ of hydrogen per m³ of oil or at most only about 200 Nm³ of hydrogen per m³ of oil or at most only about 180 Nm³ of hydrogen per m of oil or at most only about 160 Nm³ of hydrogen per m³ of oil or at most only about only about 140 Nm³ of hydrogen per m³ of oil is consumed in the hydrotreating process.

117. The method of any preceding claim wherein the hydrotreating is performed in the presence of a catalyst comprising a transition metal molybdenum catalyst such as a nickel molybdenum catalyst or a cobalt molybdenum catalyst or an aluminum-cobalt-molybdenum catalyst or an aluminum-cobalt-nickelt catalyst.

118. The method of any preceding claim wherein the pyrolyzing process is performed such that a majority, or a substantial majority, of the hydrocarbon liquids are generated when an average temperature of the type IIs kerogen is at most 290 degrees Celsius.

119. The method of any previous claim wherein the average sulfur content of the type IIs kerogen is at least 10% or at least 12%.

120. The method of any previous claim wherein the average nitrogen content of the type IIs kerogen is at least 1.75% wt/wt or at least 2% wt/wt %.

121. The method of any previous claim wherein the feedstock to the hydrotreater is the pyrolysis hydrocarbon liquids which upon entering the hydrotreater have an average sulfur content of at least 4% wt/wt or at least 5% wt/wt and/or an average nitrogen content of at least 0.75% and/or an API gravity of at most 30.

122. The method of any previous claim wherein the sulfur concentration of the sweetened crude oil is at most 0.75% or at most 0.5% or at most 0.3% or at most 0.2% or at most 0.15% or at most 0.1% wt/wt and/or the nitrogen concentration of the sweetened crude oil is at most 0.15% wt/wt or at most 0.1% wt/wt or at most 0.05% wt/wt.

123. The method of any preceding claim wherein the hydrotreating process is performed at a temperature of at most about 340 degrees Celsius, or at most about 330 degrees Celsius.

124. The method of any preceding claims wherein the API gravity of the sweetened synthetic crude oil is at least 35.

125. The method of any preceding claim wherein the pressure of the low severity hydrotreating is at most about 110 atm or at most about 100 atm or at most about 90 atm or at most 80 atm or at most 70 atm.

126. The method of any preceding claim, performed without substantial demetalizing of the pyrolysis hydrocarbon liquids before the hydrotreating.

127. The method of any preceding claim, performed in situ such that the hydrocarbon liquids are recovered via production well(s), wherein for at least one metal or at least two metals or at least three metals selected from the group nickel, arsenic and vanadium, a concentration of the metal at the production wellhead within the hydrocarbon pyrolysis liquids at the production well is on the same order of magnitude as a concentration of the metal within the feedstock to the hydrotreater.

128. The method of any preceding claim, performed in an enclosure and/or excavated enclosure such that hydrocarbon liquids are recovered from the enclosure, wherein for at least one metal or at least two metals or at least three metals selected from the group nickel, arsenic and vanadium, a concentration of the metal at the within the hydrocarbon pyrolysis liquids upon recovery from the enclosure is on the same order of magnitude as a concentration of the metal within the feedstock to the hydrotreater.

129. The hydrocarbon product comprising sweetened synthetic crude oil or a derivative thereof produced by a method of any of any preceding claim.

130. The hydrocarbon product of claim 129, wherein the hydrocarbon product is a transportation fuel.

131. A method of forming oil rich in alkylthiophenes from sulfur crossed-linked chlorophyll chains by low-temp thermal processing the sulfur crossed-linked chlorophyll chains at a temperature of between 270 and 290 degrees Celsius for at least 10,000 hours.

132. The oil formation method of claim 132 carried out in an anoxic environment.

133. The method of any of claims 132-133 wherein the sulfur crossed-linked chlorophyll chains are processed for at least 20,000 hours or at least 30,000 hours and/or at most 50,000 hours or at most 30,000 hours.

134. A pyrolysis method comprising:
heating type IIs kerogen having an average sulfur content of at least 8% wt/wt and an average nitrogen content of at least 1.5% wt/wt so as to pyrolyze at least a majority the type IIs kerogen when an average temperature thereof in a temperature range having a lower bound of 260 degrees Celsius and an upper bound of 290 degrees Celsius within a period of time of at most 5 years.

135. The method of claim 134 wherein the average temperature of the type IIs kerogen is within the temperature range for at least 6 months or at least 1 year.

136. The pyrolysis method of any of claims 134-135 wherein the average temperature of the type IIs kerogen never exceeds 290 degrees Celsius before at least a majority of the kerogen is pyrolyzed.

137. The pyrolysis method of any of claims 134-136 wherein the average temperature of the type IIs kerogen never exceeds 290 degrees Celsius.

138. The pyrolysis method of any of claims 134-137 wherein a majority of the kerogen is pyrolyzed within a period of time of at most 3 years.

139. The method of any of claims 134-138 wherein type IIs kerogen is heated by one or more heaters such that (i) during an earlier stage of heating, before the average temperature of the kerogen enters the temperature range, the heaters are operated at a higher power level; and (ii) during a later stage of heating after the average temperature of the kerogen is within the temperature range, the heaters are operated at a lower power level.

140. The method of any of claims 134-139 wherein the method includes, before an average temperature of the kerogen exceeds 290 degrees Celsius, reducing a power level at which thermal energy is delivered to the kerogen.

141. A pyrolysis method comprising:
a. heating a type IIs kerogen so as to initiate pyrolysis thereof so that hydrocarbon pyrolysis formation liquids are formed therefrom;
b. regulating a rate of the heating so as to maximize a ratio between respective concentration(s) of alkylthiophenes and alkyldibenzothiophenes and/or so as to maximize a ratio between respective concentration(s) of alkylpyrroles and alkylcarbazoles and/or so as to maximize a ratio between respective concentration(s) of alkylpyridines and alkylacridines.

142. A pyrolysis method comprising:
a. heating a type IIs kerogen so as to initiate pyrolysis thereof so that hydrocarbon pyrolysis formation liquids are formed therefrom;
b. monitoring a relationship between respective concentration(s) within the hydrocarbon pyrolysis formation liquids of alkylthiophenes and alkyldibenzothiophenes and/or a relationship between respective concentration(s) of alkylpyrroles and alkylcarbazoles and/or a relationship between respective concentration(s) alkylpyridines and alkylacridines; and
c. in response to the results of the monitoring, increasing or decreasing a rate of the heating of the type IIs kerogen.

143. The method of claim 142 wherein the heating rate of the type IIs kerogen is decreased in response to at least one of: (i) a decrease in a ratio between respective concentration(s) within the hydrocarbon pyrolysis formation liquids of alkylpyrroles and alkylcarbazoles; (ii) a decrease in a ratio between respective concentration(s) within the hydrocarbon pyrolysis formation liquids of alkylpyrroles and alkylcarbazoles; (iii) a decrease in a ratio between respective concentration(s) within the hydrocarbon pyrolysis formation liquids of alkylthiophenes and alkyldibenzothiophenes.

144. The method of any of claims 142-143 wherein the monitoring is carried out by means of chromatography.

144. The method of any preceding claim wherein the pyrolysis is carried out in an enclosure or in an excavated enclosure or in a pit or in a vessel or in a surface retort or in an impoundment or in situ.

145. The method of any preceding claim wherein the pyrolysis is performed at a pressure of at most about 12 atmospheres or at most about 8 atmospheres or at most about 4 atmospheres and/or at least 2 atmospheres or at least 3 atmospheres or at least 4 atmospheres.

146. The method of any preceding claim wherein the kerogen is pyrolyzed so that an API gravity of hydrocarbon pyrolysis liquids formed by the pyrolysis is at least 25 or at least 30°.

147. The method of any preceding claim wherein the kerogen is pyrolyzed so that pyrolysis liquids derived therefrom have any feature or combination of features of an oil of any preceding claim.

148. The hydrocarbon pyrolysis liquids or a derivative thereof of any of the preceding claims.
